(19) United States
(12) Patent Application Publication
(10) Pub. No.: US 2016/0284027 A1
(43) Pub. Date: Sep. 29, 2016

(54) SYSTEMS AND METHODS FOR MAXIMIZING TAX RETURN BY REDUCING SURCHARGE FOR MEDICARE SIMULTANEOUSLY

(71) Applicant: David T. Meeting, Stow, OH (US)

(72) Inventor: David T. Meeting, Stow, OH (US)

(21) Appl. No.: 14/669,170

(22) Filed: Mar. 26, 2015

(51) Int. Cl. G06Q 40/08; G06Q 40/00

(52) U.S. Cl. CPC G06Q 40/08; G06Q 40/123

(57) ABSTRACT

The present invention provides a system and methods of minimizing the out of pocket costs associated with Medicare Part B and Part D premiums. The invention provides the user with information for saving costs relating to Medicare premiums currently, and for future planning. The invention also provides a system to evaluate the potential impact of a Life-Changing Event under the Medicare system, both for current saving and future planning.

### FIELD OF THE INVENTION

The systems and methods of this invention relate generally to minimizing expenditures by reducing potential surcharges possibly incurred as a part of Medicare benefits for individuals. More particularly, the methods and systems provide mechanism to limit exposure to surcharges of the Medicare Part B and Part D in the future, and to assess the possible cost savings upon the occurrence of a Life-Changing Event.

### BACKGROUND OF THE INVENTION

As part of financial planning activities, practicing CPA's, financial and retirement planners are unaware of the laws regarding Medicare Part B and Part D surcharges and how to limit exposure to such surcharges. For many people, the Modified Adjusted Gross Income (MAGI) used in association with income tax filings and the choice of income tax filing status determine the Medicare Part B and Part D premiums. Individuals may pay more out of their pocket in Medicare Part B and Part D premiums than they should. The Medicare Part B and Part D premium surcharges could result in individuals paying significantly greater amounts of Medicare Part B and Part D premiums in the current and future years based on the various factors that are possibly realized as a result of the MAGI and income tax filing status used by an individual. It would be worthwhile to provide a system and methods for reducing out of pocket expenses relating to Medicare benefits.

### SUMMARY OF THE INVENTION

The present invention provides a system and methods of minimizing the out of pocket costs associated with Medicare Part B and Part D premiums. The invention provides the user with information for saving costs relating to Medicare premiums currently, and for future planning. The invention also provides a system to evaluate the potential impact of a Life-Changing Event under the Medicare system, both for current saving and future planning.

### BRIEF DESCRIPTION OF DRAWINGS

In the detailed description of various embodiments of the present invention presented below, reference is made to the accompanying drawings, in which:

FIG. 1 depicts a diagram of an example of a system in accordance with the present invention which can determine the minimum possible Medicare Part B and Part D premiums for a married couple or individual under predetermined circumstances.

FIG. 2 depicts a diagram of a system in accordance with another example of a system in accordance with the present invention which can determine the minimum possible Medicare Part B and Part D premiums for an individual under predetermined circumstances.

FIG. 3 depicts a diagram of a system in accordance with another example of a system in accordance with the present invention which can facilitate planning over a period of years to minimize possible Medicare Part B and Part D premiums for an individual.

FIG. 4 depicts a diagram of a system in accordance with another example of a system in accordance with the present invention which can facilitate planning over a period of a year to minimize possible Medicare Part B and Part D premiums for an individual.

FIG. 5 depicts a diagram of a system in accordance with another example of a system in accordance with the present invention which can facilitate planning to minimize possible Medicare Part B and Part D premiums for a married couple or individual.

FIG. 6 depicts a diagram of a system in accordance with another example of a system in accordance with the present invention which can facilitate planning over a period of years to minimize possible Medicare Part B and Part D premiums for a married couple.

FIG. 7 depicts a diagram of a system in accordance with another example of a system in accordance with the present invention which can facilitate planning over a period of a year to minimize possible Medicare Part B and Part D premiums for a married couple.

### DETAILED DESCRIPTION OF THE INVENTION

Medicare was established in 1966 to finance healthcare benefits for senior citizens aged 65 and older. Medicare consists of three parts: A, B, and D. People mostly do not pay a premium for Part A and anyone who qualifies for Social Security benefits will automatically receive the Part A benefits starting the first day of the month the individual turns 65. Medicare Part B Premiums prior to 2007 were the same amount regardless of the beneficiary's income or income tax filing status. However, the Medicare Prescription Drug, Improvement, and Modernization Act of 2003 (MMA) initiated a means test for “upper income” Part B beneficiaries. The premium for Part B, wherein the coverage begins the first day of the month a person turns 65, now depends on the most recent tax information provided by the IRS. For example, the Modified Adjusted Gross Income (MAGI) of 2013 determines the Medicare Part B and Part D premiums of year 2015. Since the Modified Adjusted Gross Income (MAGI) is equal to Adjusted Gross Income (AGI) on line 37 of IRS form 1040 plus tax-exempt interest income (line 8b of IRS form 1040), failure to take this additional variable into account may result in the individual paying significantly greater Medicare Part B and Part D premiums by using the wrong filing status.

Under the Medicare system, the tax return filed in one year (for the prior tax year) is used to determine the Part B Premiums for the next year. For most individual taxpayers with a modified adjusted gross income (MAGI) less than $85,000.01 and a couple filing a joint return with a MAGI less than $170,000.01, the government pays 75% of the cost of Part B and the beneficiary pays only 25%. Single filers with a MAGI>$85,000, Married Filing Jointly (MFJ) filers with a MAGI>$170,000 and Married Filing Singly (MFS) with a MAGI>$85,000 will pay a monthly premium equal to 35%, 50%, 65% or 80% of the total cost of Part B, based on their income levels. For example, for 2014 the basic Medicare Part B Premium is $104.90 per month. Higher income individuals pay an additional surcharge beyond the basic premium as shown in Tables 1 & 2 below. The Income-Related Monthly Adjustment Amount (IRMAA) surcharge is based on MAGI and the income tax filing status used on the tax return filed two years ago. For example, the 2013 Medicare Part B Premium including IRMAA was determined by the tax return filed for the year 2011 and the 2014 Medicare Part B Premium including IRMAA was determined by the tax return filed for the year 2012. Thus, the tax return filed for the year 2013 will determine the 2015 Medicare Part B Premium including IRMAA, and so on.

TABLE 1
Monthly Medicare Part B premium plus surcharge for people
who filed as an individual tax return or married filed
jointly (MFJ) for 2014

| | | Prescription |
|---|---|---|
| | Part B | drug coverage |
| | monthly | monthly |
| Modified Adjusted | premium | premium |
| Gross Income (MAGI) | amount | amount |
| Individuals with a MAGI | 2014 | Your plan |
| of $85,000 or less | standard | premium |
| Married couples with a | premium = | |
| MAGI of $170,000 or less | $104.90 | |
| Individuals with a MAGI | Standard | Your plan |
| above $85,000 up to $107,000 | premium + | premium + |
| Married couples with a MAGI | $42.00 | $12.10 |
| above $170,000 up to $214,000 | | |
| Individuals with a MAGI above | Standard | Your plan |
| $107,000 up to $160,000 | premium + | premium + |
| Married couples with a MAGI | $104.90 | $31.10 |
| above $214,000 up to $320,000 | | |
| Individuals with a MAGI above | Standard | Your plan |
| $160,000 up to $214,000 | premium + | premium + |
| Married couples with a MAGI | $167.80 | $50.20 |
| above $320,000 up to $428,000 | | |
| Individuals with a MAGI | Standard | Your plan |
| above $214,000 | premium + | premium + |
| Married couples with a | $230.80 | $69.30 |
| MAGI above $428,000 | | |

TABLE 2
Monthly Medicare Part B premium plus surcharge for people
who filed as married filed separately (MFS) for 2014

| | | Prescription |
|---|---|---|
| | Part B | drug coverage |
| | monthly | monthly |
| Modified Adjusted | premium | premium |
| Gross Income (MAGI) | amount | amount |
| Individuals with a MAGI | 2013 | Your plan |
| of $85,000 or less | standard | premium |
| | premium = | |
| | $104.90 | |
| Individuals with a MAGI above | Standard | Your plan |
| $85,000 up to $129,000 | premium + | premium + |
| | $167.80 | $50.20 |
| Individuals with a MAGI | Standard | Your plan |
| above $129,000 | premium + | premium + |
| | $230.80 | $69.30 |

As described, financial and/or retirement planning for the Medicare Part B and Part D premiums require that planning cycles must be at least two years and preferably longer. The reason for this is that the MAGI and income tax filing status of two years ago determines the Medicare Part B and Part D Premiums of the current year. For example, the 2012 federal income tax return's MAGI and filing status determined the Medicare Part B and Part D Premiums of 2014. Financial planning to minimize the Medicare Part B and Part D premiums for 2014 must have been performed before filing the 2012 income tax return in April of 2013. Timing the receipt of MAGI to lower Medicare Part B and Part D IRMAA surcharges for 2014 would have to have been completed before Dec. 31, 2012. The only way to change the 2014 Medicare Part B and Part D premiums is by filing an amended 2012 tax return and/or by having a Life-Changing Event (LCE) and filing Form SSA-44. A Life-Changing Event and filing Form SSA-44 may result in significant savings in Medicare Part B and Part D premiums. There may be some opportunities to use SSA-44 to lower Medicare premiums if a person meets the requirement to use the form. The examples of Life-Changing Event are provided as below in Table 3.

TABLE 3
Examples of Life-Changing Event

| Life-Changing | |
|---|---|
| Event (LCE) | Use this category if |
| Marriage | You entered into a legal marriage |
| Divorce/ | Your legal marriage ended, and you will not file a joint |
| Annulment | return with your spouse for the year |
| Death of | Your spouse died |
| Your Spouse | |
| Work Stoppage | You or your spouse stopped working or reduced the |
| or Reduction | hours that you work |
| Loss of | You or your spouse experienced a loss of income- |
| Income- | producing property that was not at your direction (e.g., |
| Producing | not due to the sale or transfer of the property). This |
| Property | includes loss of real property in a Presidentially or |
| | Gubernatorially-declared disaster area, destruction of |
| | livestock or crops due to natural disaster or disease, or |
| | loss of property due to arson, or loss of investment |
| | property due to fraud or theft. |
| Loss of | You or your spouse experienced a scheduled cessation, |
| Pension | termination, or reorganization of an employer's pension |
| Income | |
| Employer | You or your spouse receive a settlement from an |
| Settlement | employer or former employer because of the |
| Payment | employer's bankruptcy or reorganization. |

Furthermore, Medicare beneficiaries currently paying the maximum IRMAA may reduce expenditures by “shifting” future MAGI into the current year or future year to avoid paying the maximum IRMAA in a year. For example, a single person with a MAGI of $220,000 each year is able to “shift” an amount (i.e. $7,000) from one year to another could reduce the surcharge in the year where the MAGI is a predetermined amount (i.e. $213,000). This works best near IRMAA borders. This can save the Medicare Part B and Part D premiums without a LCE, but can also be combined with a LCE and filing SSA-44. This also may apply to married individuals and may take into account the different possible tax filing statuses for the married individual.

In general, the systems and methods of the invention provide the ability for a married or unmarried individual to minimize the expenditures relating to Medicare Part B and Part D premiums with or without a LCE, as well as the ability to plan ahead for one or more years to minimize the expenditures relating to Medicare Part B and Part D premiums with or without a LCE. These aspects of the invention will be described relative to various examples.

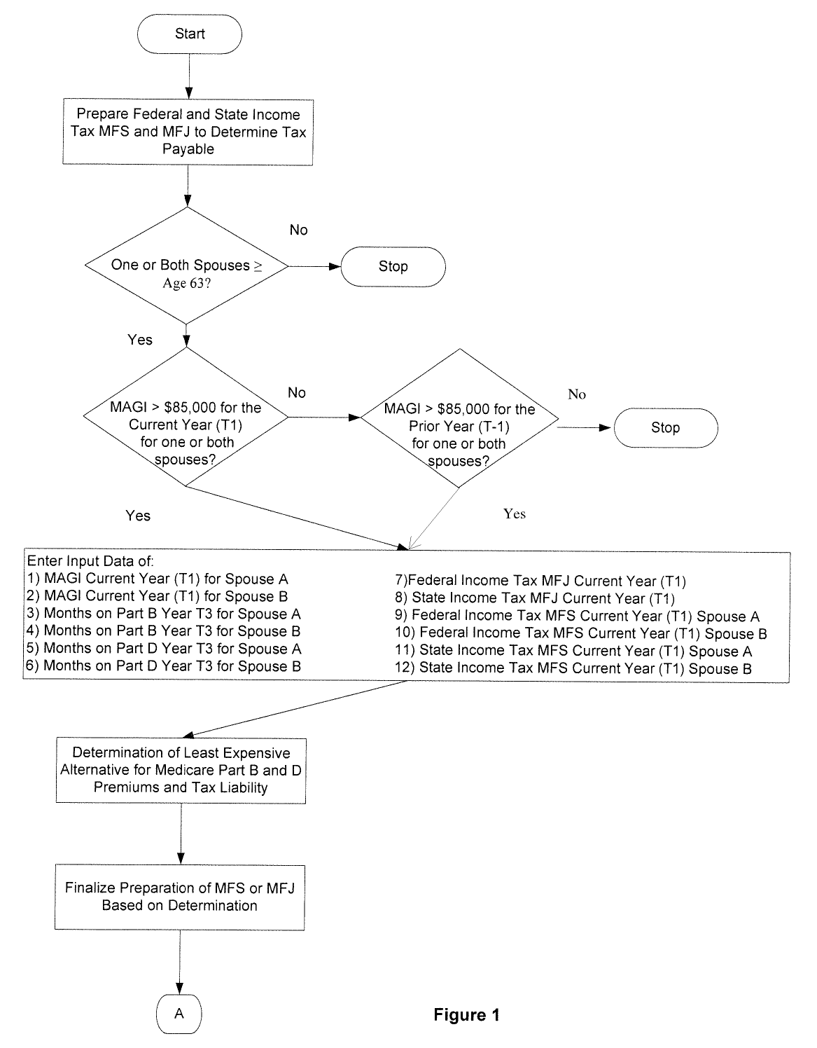

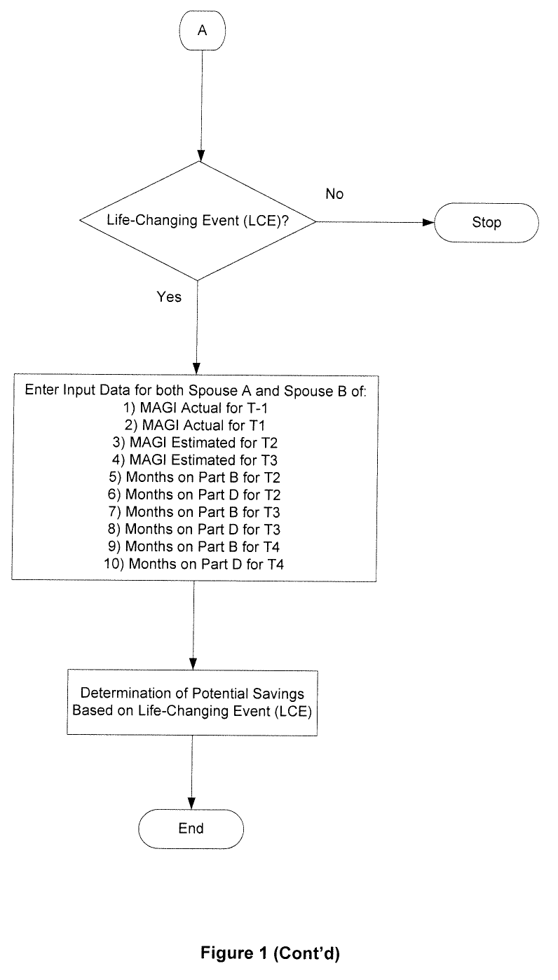

FIG. 1 represents a system in accordance with an example of the present invention for determining the least cost associated with Medicare Part B and Part D premiums in association with tax filing status and possible occurrence of a Life-Changing Event. It furthermore depicts interactions between a status for filing of tax returns and the determination of Medicare Part B and Part D premium surcharges using embodiments of the systems and methods.

In this example, the system provides for determination of the possible impact of Medicare premium surcharges on a married individual, and looks at a period of time in relation to a current year, which may be represented as T1. In the system, the prior year may be represented as T−1, while the next years may be represented as T2, T3 and T4 for example. The system requires the inputs of: (a) MAGI for the current year (T1) for spouse A & spouse B, (b) months on Part B for the second year from the current year (T3) for spouse A & spouse B, and (c) months on Part D for the second year from the current year (T3) for spouse A & spouse B. In this manner, the system allows for determining which tax filing status in combination with Medicare premiums and surcharges produces the least cost to the married individual. For a current year, the individual may have the opportunity to file with different status, such as (a) Federal Income Tax under status of Married Filing Jointly (MFJ) for the current year T1, (b) State Income Tax under status of Married Filing Jointly (MFJ) for the current year (T1), (c) Federal Income Tax under status of Married Filing Separately (MFS) for the current year (T1) for spouse A & spouse B, and (d) State Income Tax married filing separately (MFS) for the current year (T1) for spouse A & spouse B.

Then, the system determines the least expensive alternative for Medicare Part B and Part D premiums for spouse A and spouse B and tax liability for filing under status of Married Filing Jointly (MFJ) and Married Filing Separately (MFS) for the second year from the current year (T3). The system also determines the Married Filing Jointly (MFJ) and Married Filing Separately (MFS) filing penalty for the second year from the current year (T3). The system further determines the total of Federal Income Tax, State Income Tax and Medicare Part B and Part D premiums for Married Filing Jointly (MFJ) and Married Filing Separately (MFS). In this manner, the system determines the income tax filing status to be used that results in the lowest total of Medicare Part B and Part D premiums along with Federal Income Tax and State Income Tax. The system may also determine the amount of savings from use of the income tax filing status that produces the lowest total expenses.

As an optional or separate further stage, if an individual has experienced a Life-Changing Event (LCE), a Form SSA-44 can be elected for the next year (T2). The system may determine the least expensive Medicare benefits based on the LCE. The following input data for both spouse A and spouse B is put into the system: (a) MAGI for the previous year (T−1), (b) MAGI for the current year (T1), (c) MAGI estimated for the next year from the current year (T2), (d) MAGI estimated for the second year from the current year (T3), (e) months on Part B for the next year from the current year (T2), (f) months on Part D for the next year from the current year (T2), (g) months on Part B for the second year from the current year (T3), (h) months on Part D for the second year from the current year (T3), (i) months on Part B for the third year from the current year (T4) and (j) months on Part D for the third year from the current year (T4). Then, the system determines the Medicare Part B and Part D premiums for spouse A and spouse B for filing Married Filing Jointly (MFJ) and Married Filing Separately (MFS) status for T2 using the MAGI of T−1, T1 and T2 to calculate the lowest Medicare Part B and Part D premiums for T2 by filing Form SSA-44, Medicare Income Related Monthly Adjustment Amount Life Changing Event (SSA-44).

According to an example, the system determines the Married Filing Jointly (MFJ) and Married Filing Separately (MFS) Medicare Part B and Part D premiums for T2, T3 and T4 for the following conditions:

1. Not Filing SSA-44

2. Filing SSA-44 using T1 MAGI

3. Filing SSA-44 using T2 MAGI

4. Filing SSA-44 using T2 and T3 MAGI

The system determines the savings from filing SSA-44 and using the MAGI of T1, T2 and T2 and T3, so that the Medicare beneficiary can pay the least amount of Medicare Part B and Part D premiums. The Medicare beneficiary would then file a SSA-44, and use the years MAGI that will result in the lowest amount of Medicare Part B and Part D Premiums for T2, T3 and T4. If individuals use the wrong years MAGI, it may result in the overpayment of Medicare Part B and Part D premiums. Failure to promptly file SSA-44 may also result in the overpayment of Medicare Part B and Part D premiums.

As an example, the current year may be 2013, and T−1 is 2012, while T2=2014, T3=2015 and T4=2016. The system operates to minimize expenses relating to Medicare premiums if the individual is married and has the opportunity to file income tax returns based on the filing status of Married Filing Jointly (MFJ) or Married Filing Separately (MFS). If spouse A has a MAGI in 2013 of $132,000 and spouse B has a MAGI of $158,000, these values can be input into the system, along with the months that spouses A and B will be eligible for Medicare benefits in the second year from the current year or T3, which in this example, is 12 months for both spouses. The federal and state tax liability for each spouse is determined by evaluating filing under the filing status of Married Filing Jointly (MFJ) and Married Filing Separately (MFS), which in this example is $64,621 for federal tax under MFJ and $12,022 for state tax under MFJ (or another amount based on a state's tax schemes). Under MFS, the federal income tax for spouse A is $28,021 and for spouse B is $36,807, while state income tax under MFS is $4,521 for spouse A and $5,818 for spouse B (or another amount based on a state's tax schemes). Thereafter, the system determines the Medicare premiums due for Parts B and D for spouses A and B for MFJ and MFS statuses. In this example, under MFJ status, the couple will pay $5,781.60 in Medicare premiums, while for MFS, spouse A would pay $4,860.00 and spouse B would pay $4,860.00 for a total of $9,720.00.

Under this example, the system determines that this couple would save $1,476.00 in income tax by filing the income tax returns under the status of MFS. The system then determines the Medicare Part B and Part D premiums that will be due for the couple if they were to file MFJ and MFS, which in this example, results in each spouse paying $2,890.80 when filing MFJ and spouse A paying $4,860 when filing MFS and spouse B paying $4,860 when filing MFS. This results in a penalty of $3,938.40 if the MFS filing status is used. The savings in Medicare Part B and Part D premiums from filing MFJ of $3,938.40 more than makes up for the additional income tax of $1,476 from filing MFJ. The net result is that by filing MFJ versus MFS, spouse A and B save $2,462.40 in federal income tax, state income tax and Medicare Part B and Part D premiums. In this example, filing status based solely on income tax filing status would result in the overpayment of Medicare Part B and Part D premiums by $3,938.40. Based upon this example, spouses A and B will file MFJ to avoid the penalty in Medicare premiums and surcharges which is larger than the savings in income tax from filing MFS.

Another example in relation to the system of FIG. 1, the impact of the possible occurrence of a Life-Changing Event for a married individual may be evaluated in addition to or separately from the above. The system may be used to determine the viability of using the Medicare rules relating to a Life-Changing Event (LCE). As an example, for spouses A and B, the system will use the inputs of a) MAGI for the previous year (T−1)(2012) for spouse A=$148,000 and for spouse B=$160,000, (b) MAGI for the current year 2013 (T1) for spouse A=$132,000 and for spouse B=$158,000, (c) MAGI estimated for the next year from the current year 2014 (T2) for spouse A=$95,000 and for spouse B=$100,000, (d) MAGI estimated for the second year from the current year 2015 (T3) for spouse A=$75,000 and for spouse B=$90,000, (e) months on Part B for the next year from the current year 2014 (T2) for spouse A=6 months and for spouse B=6 months, (f) months on Part D for the next year from the current year 2014 (T2) for spouse A=6 months and for spouse B=6 months, (g) months on Part B for the second year from the current year 2015 (T3) for spouse A=12 months and for spouse B=12 months, (h) months on Part D for the second year from the current year 2015 (T3) for spouse A=12 months and for spouse B=12 months, months on Part B for the third year from the current year 2016 (T4) for spouse A=12 months and for spouse B=12 months and months on Part D for the third year from the current year 2016 (T4) for spouse A=12 months and for spouse B=12 months. The system then determines the Married Filing Jointly (MFJ) and Married Filing Separately (MFS) Medicare Part B and Part D premiums for T2 (2014), T3 (2015) and T4 (2016) for the following conditions: 1) Not Filing SSA-44; 2) Filing SSA-44 using T1 MAGI; 3) Filing SSA-44 using T2 MAGI; and 4) Filing SSA-44 using T2 and T3 MAGI.

The system determines the savings from filing SSA-44 and using the MAGI of T1 and T2 so that the Medicare beneficiary can pay the least amount of Medicare Part B and Part D premiums in T2 (2014). In this example, the Medicare Part B and D premiums for the couple filing MFJ would be $2,890.80 using T−1 (2012) MAGI, $2,890.80 using T1 (2013) MAGI, $1,908 using T2 (2014). This results in a determination that the couple should not file an SSA-44 form for a LCE using the MAGI for the year T1 (2013), as this would result no savings in Medicare premiums. But using the MAGI for T2 (2014), filing the SSA-44 would result in a savings of $982.80 indicating a SSA-44 should be filed. The system also provides the ability to plan ahead using the estimated MAGI for upcoming years under the scenario of filing MFJ, determining the results if the couple were not to file the SSA-44, were to file the SSA-44 using the 2013 (T1) MAGI, to file the SSA-44 using the 2014 (T2) MAGI and to file the SSA-44 using the 2014 (T2) and 2015 (T3) MAGI. In this example, the Part B and D premiums for the years 2014-2016 were determined for the couple under these different SSA-44 filing possibilities. The results in this example indicate that by not filing the SSA-44, the couple will pay $2,890.80 in 2014, $5,781.60 in 2015 and $3,816 in 2015, for a total of $12,488.40. By filing the SSA-44 using the T1 (2013) MAGI, the couple will pay $2,890.80 in 2014, $5,781.60 in 2015 and $3,816 in 2016, for a total of $12,488.40. This results in no Medicare Part B and Part D premium savings and indicates the couple should not file SSA-44 under these circumstances. By filing the SSA-44 using the T2 (2014) MAGI, the couple will pay $1908 in 2014, $3,816 in 2015 and $3,816 in 2016, for a total of $9,540. This results in a savings of $2,948.40 and indicates the couple should file SSA-44 under these circumstances. By filing the SSA-44 using the T2 (2014) and T3 (2015) MAGI, the couple will pay $1,908.00 in 2014, $2,517.60 in 2015 and $2,517.60 in 2016, for a total of $6,943.20. This results in a savings of $5,545.20 and indicates the couple should file SSA-44 under these circumstances. The Medicare beneficiary would then file a SSA-44 and use the years MAGI that will result in the lowest amount of Medicare Part B and Part D Premiums for T2, T3 and T4. If individuals use the wrong years MAGI, it may result in the overpayment of Medicare Part B and Part D premiums.

In this example, the Medicare Part B and D premiums for the couple filing MFS would be $4,860 using T−1 (2012) MAGI, $4,860 using T1 (2013) MAGI and $3,874.80 using T2 (2014) MAGI. This results in a determination that the couple should not file an SSA-44 form for a LCE using the MAGI for the year 2013, as this would result in no savings in Medicare Premiums. Using the MAGI of 2014, filing the SSA-44 would result in a savings of $985.20 indicating a SSA-44 should be filed. The system also provides the ability to plan ahead using the estimated MAGI for upcoming years under the scenario of filing MFS, determining the results if the couple were not to file the SSA-44, were to file the SSA-44 using the 2013 (T1) MAGI, to file the SSA-44 using the 2014 (T2) MAGI and to file the SSA-44 using the 2014 (T2) and 2015 (T3) MAGI. In this example, the Part B and D premiums for the years 2014-2016 were determined for the couple under these different SSA-44 filing possibilities. The results in this example indicate that by not filing the SSA-44, the couple will pay $4,860.00 in 2014, $9,720.00 in 2015 and $7,749.60 in 2016, for a total of $22,329.60. By filing the SSA-44 using the T1 (2013) MAGI, the couple will pay $4,860.00 in 2014, $9,720.00 in 2015 and $7,749.60 in 2016, for a total of $22,329.60. This results in no savings, and indicates the couple should not file SSA-44 under these circumstances. By filing the SSA-44 using the T2 (2014) MAGI, the couple will pay $3,874.80 in 2014, $7,749.60 in 2015 and $7,749.60 in 2016, for a total of $19,374. This results in a savings of $2,955.60 and indicates the couple should file SSA-44 under these circumstances. By filing the SSA-44 using the T2 (2014) and T3 (2015) MAGI, the couple will pay $3,874.80 in 2014, $5,133.60 in 2015 and $5,133.60 in 2016, for a total of $14,142.00. This results in a savings of $8,187.60 and indicates the couple should file SSA-44 under these circumstances. The Medicare beneficiary would then file a SSA-44 and use the years MAGI that will result in the lowest amount of Medicare Part B and Part D Premiums for T2, T3 and T4. If individuals use the wrong years MAGI, it may result in the overpayment of Medicare Part B and Part D premiums.

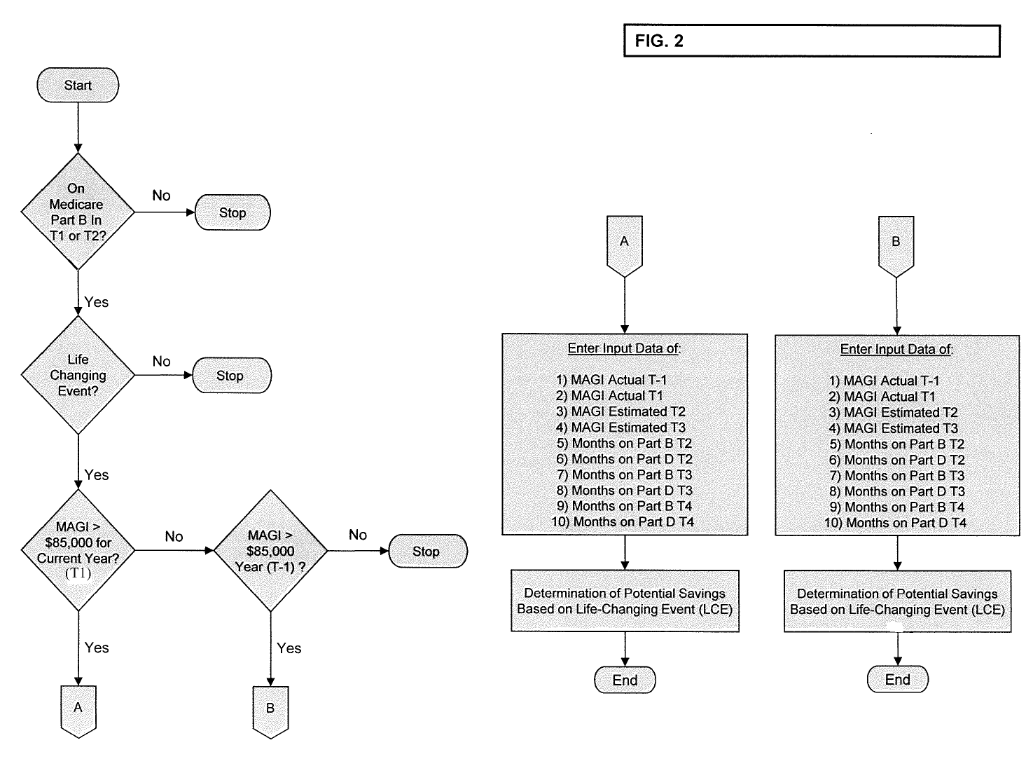

With reference to FIG. 2, in an example for an unmarried individual, the system in this example, provides for determination of the possible impact of Medicare premium surcharges on an unmarried individual, and looks at a period of time in relation to a current year, which may be represented as T1. In the system, the prior year may be represented as T−1, while the next years may be represented as T2, T3 and T4 for example. The system determines whether the individual is on Medicare in years T1 or T2, and whether the individual has experienced an LCE. If yes, the system determines whether the MAGI for the current year and past year is greater than the amount required to invoke surcharges, and if so, requires the inputs of: (a) MAGI for the past year (T−1); (b) MAGI for the current year (T1), estimated MAGI for the next year (T2); estimated MAGI for the second year from the current year (T3); months on Part B and Part D for the first year from the current year (T2); months on Part B and Part D for the second year from the current year (T3) and months on Part B and Part D for the third year from the current year (T4). The system then determines the potential savings based on the occurrence of a LCE.

In an example, the system will use the inputs of (a) MAGI for the previous year T−1 (2012)=$215,000, (b) MAGI for the current year T1 (2013)=$175,000, (c) MAGI estimated for the next year from the current year T2 (2014)=$110,000, (d) MAGI estimated for the second year from the current year T3 (2015)=$84,000, (e) months on Part B for the next year from the current year T2 (2014)=11 months, (f) months on Part D for the next year from the current year T2 (2014)=11 months, (g) months on Part B for the second year from the current year T3 (2015)=12 months, (h) months on Part D for the second year from the current year T3 (2015) T3)=12 months, (i) months on Part B for the third year from the current year T4 (2016)=12 months and months on Part D for the third year from the current year T4 (2016)=12 months. The system then determines the Medicare Part B and Part D premiums for T2 (2014), T3 (2015) and T4 (2016) for the following conditions:

### 1. Not Filing SSA-44

2. Filing SSA-44 using T1 (2013) MAGI
3. Filing SSA-44 using T2 (2014) MAGI
4. Filing SSA-44 using T2 (2014) and T3 (2015) MAGI

The system determines the savings from filing SSA-44 and using the MAGI of T1 and T2 so that the Medicare beneficiary can pay the least amount of Medicare Part B and Part D premiums in T2 (2014). In this example, the Medicare Part B and D premiums for the individual would be $4,455 using T−1 (2012) MAGI, $3,551.90 using T1 (2013) MAGI, $2,649.90 using T2 (2014). This results in a determination that the individual should file an SSA-44 form for a LCE using the MAGI for the year T1 (2013), as this would result in savings of Medicare premiums $903.10, but using the MAGI for T2 (2014), filing the SSA-44 would result in a savings of $1,805.10 indicating a SSA-44 should be filed using the MAGI for T2 (2014). The system also provides the ability to plan ahead using the estimated MAGI for upcoming years under the scenario of not filing the SSA-44, were to file the SSA-44 using the T1 (2013) MAGI, to file the SSA-44 using the T2 (2014) MAGI and to file the SSA-44 using the T2 (2014) and T3 (2015) MAGI. In this example, the Part B and D premiums for the years T2 (2014)-T4 (2016) were determined for the individual under these different SSA-44 filing possibilities. The results in this example indicate that by not filing the SSA-44, the individual will pay $4,455.00 in T2 (2014), $3,874.80 in T3 (2015) and $2,890.80 in T4 (2016), for a total of $11,220.60. By filing the SSA-44 using the T1 (2013) MAGI, the individual will pay $3,551.90 in T2 (2014), $3,874.80 in T3 (2015) and $2,890.80 in T4 (2016), for a total of $10,317.50. This results in a Medicare Part B and Part D premium savings of $903.10 and indicates the individual should file SSA-44 under these circumstances. By filing the SSA-44 using the T2 (2014) MAGI, the individual will pay $2,649.90 in T2 (2014), $2,890.80 in T3 (2015) and $2,890.80 in T4 (2016), for a total of $8,431.50. This results in a savings of $2,789.10 and indicates the individual should file SSA-44 under these circumstances. By filing the SSA-44 using the T2 (2014) and T3 (2015) MAGI, the individual will pay $2,649.90 in T2 (2014), $1,258.80 in T3 (2015) and $1,258.80 in T4 (2016), for a total of $5,167.50. This results in a savings of $6,053.10 and indicates the individual should file SSA-44 under these circumstances. The Medicare beneficiary would then file a SSA-44 and use the years MAGI that will result in the lowest amount of Medicare Part B and Part D Premiums for T2, T3 and T4. If individuals use the wrong years MAGI, it may result in the overpayment of Medicare Part B and Part D premiums.

In another example for an individual, the system will use the inputs of a) MAGI for the previous year T−1 (2012)=$215,000, (b) MAGI for the current year T1 (2013)=$150,000, (c) MAGI estimated for the next year from the current year T2 (2014)=$105,000, (d) MAGI estimated for the second year from the current year T3 (2015)=$84,000, (e) months on Part B for the next year from the current year T2 (2014)=12 months, (f) months on Part D for the next year from the current year T2 (2014)=12 months, (g) months on Part B for the second year from the current year T3 (2015)=12 months, (h) months on Part D for the second year from the current year T3 (2015)=12 months, (i) months on Part B for the third year from the current year T4 (2016)=12 months and months on Part D for the third year from the current year T4 (2016)=12 months. The system then determines the Medicare Part B and Part D premiums for T2 (2014), T3 (2015) and T4 (2016) for the following conditions:

### 1. Not Filing SSA-44

2. Filing SSA-44 using T1 (2013) MAGI
3. Filing SSA-44 using T2 (2014) MAGI
4. Filing SSA-44 using T2 (2014) and T3 (2015) MAGI

The system determines the savings from filing SSA-44 and using the MAGI of T1 and T2 so that the Medicare beneficiary can pay the least amount of Medicare Part B and Part D premiums in T2 (2014). In this example, the Medicare Part B and D premiums for the individual would be $4,860.00 using T−1 (2012) MAGI, $2,890.80 using T1 (2013) MAGI, $1908.00 using T2 (2014). This results in a determination that the individual should file an SSA-44 form for a LCE using the MAGI for the year T1 (2013), as this would result in savings of Medicare premiums $1,969.20, but using the MAGI for T2 (2014), filing the SSA-44 would result in a savings of $2,952.00 indicating a SSA-44 should be filed using the MAGI for T2 (2014). The system also provides the ability to plan ahead using the estimated MAGI for upcoming years under the scenario of not filing the SSA-44, were to file the SSA-44 using the T1 (2013) MAGI, to file the SSA-44 using the T2 (2014) MAGI and to file the SSA-44 using the T2 (2014) and T3 (2015) MAGI. In this example, the Part B and D premiums for the years T2 (2014)-T4 (2016) were determined for the individual under these different SSA-44 filing possibilities. The results in this example indicate that by not filing the SSA-44, the individual will pay $4,860.00 in T2 (2014), $2,980.80 in T3 (2015) and $1,908.00 in T4 (2016), for a total of $9,658.80. By filing the SSA-44 using the T1 (2013) MAGI, the individual will pay $2,890.80 in T2 (2014), $2,890.80 in T3 (2015) and $1,908.00 in T4 (2016), for a total of $7,689.60. This results in a Medicare Part B and Part D premium savings of $1,969.20 and indicates the individual should file SSA-44 under these circumstances. By filing the SSA-44 using the T2 (2014) MAGI, the couple will pay $1,908.00 in T2 (2014), $1,908.00 in T3 (2015) and $1,908.00 in T4 (2016), for a total of $5,724.00. This results in a savings of $3,934.80 and indicates the individual should file SSA-44 under these circumstances. By filing the SSA-44 using the T2 (2014) and T3 (2015) MAGI, the individual will pay $1,908.00 in T2 (2014), $1,258.80 in T3 (2015) and $1,258.80 in T4 (2016), for a total of $4,425.60. This results in a savings of $5,233.20 and indicates the couple should file SSA-44 under these circumstances. The Medicare beneficiary would then file a SSA-44 and use the years MAGI that will result in the lowest amount of Medicare Part B and Part D Premiums for T2, T3 and T4. If individuals use the wrong years MAGI, it may result in the overpayment of Medicare Part B and Part D premiums.

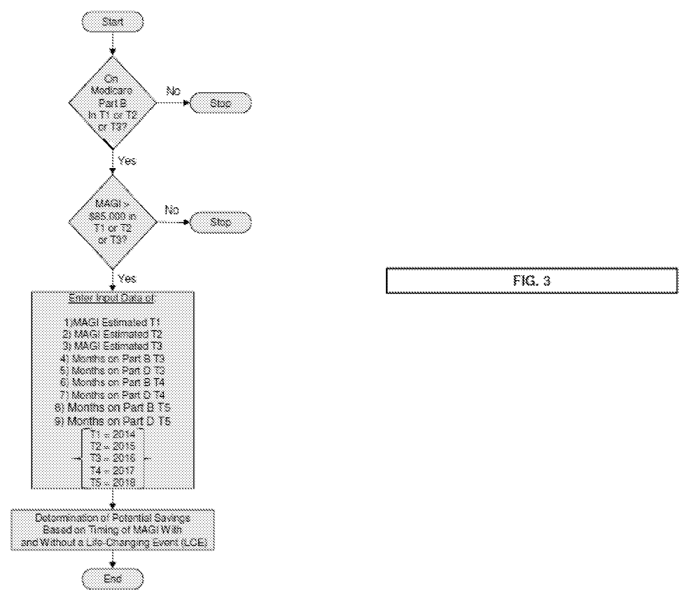

FIG. 3 represents a system in accordance with an example of the present invention for determining the least cost associated with Medicare Part B and Part D premiums for a three year planning period and possible occurrence of a Life-Changing Event (LCE). It furthermore depicts the determination of minimum Medicare Part B and Part D premium surcharges using embodiments of the systems and methods.

The system provides for financial and/or retirement planning in relation to the determination of the possible impact of Medicare premium surcharges on an individual, and looks at a period of time in relation to a current year, which may be represented as T1. In the system, the prior year may be represented as T−1, while the next years may be represented as T2, T3 and T4 for example. In an example, the current year may be 2013, and T−1 is 2012, while T2=2014, T3=2015, T4=2016 T5=2016 and T6=2018.

The system is a three year financial and/or retirement planning system to determine and minimize the Medicare Part B and Part D premiums for T4 (2016), T5 (2017) and T6 (2018) that is used in T1 (2013) or early in year T2 (2014). Since the MAGI of T2 (2014) determines the Medicare Part B and Part D premium of T4 (2016), the MAGI of T3 (2015) determines the Medicare Part B and Part D premium of T5 (2017) and the MAGI of T4 (2016) determines the Medicare Part B and Part D premium of T6 (2018), the systems uses the estimated MAGI of T2 (2014), T3 (2015) and T4 (2016) as input data. Since the system is future oriented, the Medicare beneficiaries can plan and time financial transactions that increase or decrease MAGI between years to minimize Medicare Part B and Part D premiums in the future. The system has two major components, financial and/or retirement planning without a Life-Changing Event (LCE) and financial and/or retirement planning with a Life-Changing Event. The system without a Life-Changing Event is first described. The system may utilize iterations to evaluate different possible scenarios for the individual in terms of future years planning. In an example, the following input data for the individual is put into the system for Iteration 1: (a) estimated MAGI for the year T2 (2014), (b) estimated MAGI for the year T3 (2015), (c) estimated MAGI for the year T4 (2016), (d) months on Part B for the year T4 (2016), (e) months on Part D for the year T4 (2016), (f) months on Part B for the year T5 (2017), (g) months on Part D for the year T5 (2017), (h) months on Part B for T6 (2018) and (i) months on Part D for T6 (2018). For additional iterations, different inputs relating to (a) estimated MAGI for the year T2 (2014), (b) estimated MAGI for the year T3 (2015) and (c) MAGI estimated for the year T4 (2016) are input, such as for Iterations 2-4. Then, the system determines the Medicare Part B and Part D premiums for T4 (2016), T5 (2017) and T6 (2018) for Iteration 1, Iteration 2, Iteration 3 and Iteration 4. The system allows the financial and/or retirement planner to do “what if” type computations by including additional or other data from financial transactions into the MAGI for Iteration 2, Iteration 3 and Iteration 4 to determine the effect of a financial transaction(s) on Medicare Part B and Part D premiums, and possible surcharges.

In an example, the system determines the difference between:
Iteration 2 less Iteration 1,
Iteration 3 less Iteration 1,
Iteration 3 less Iteration 2,
Iteration 4 less Iteration 1,
Iteration 4 less Iteration 2,
Iteration 4 less Iteration 3, and so on for possible additional iterations.
These differences are determined for MAGI of T2 (2014), MAGI of T3 (2015) and MAGI T4 (2016) and Medicare Part B and Part D premiums for T4 (2016), T5 (2017) and T6 (2018). The system determines that for a change in MAGI from Iteration one to Iteration Two, etc., the amount of change in Medicare Part B and Part D premiums.

Significant savings in Medicare Part B and Part D premiums could occur when an individual has or will experience a Life-Changing Event (LCE) and files a Form SSA-44. Some LCEs can be planned for such as work stoppage or reduction. The system has a second component that determines the Medicare Part B and Part D premiums with a LCE. This component of the system uses that input data from above and requires no additional input data. If an individual will or does experience a Life-Changing Event (LCE), a Form SSA-44 can be elected. The system determines the least expensive Medicare Part B and Part D premiums based on the LCE. Then, the system determines the Medicare Part B and Part D premiums for T4, T5 and T6 using the MAGI of T2, T3, and T4 to calculate the lowest Medicare Part B and Part D premiums by filing Form SSA-44, Medicare Income Related Monthly Adjustment Amount Life Changing Event (SSA-44). The system determines the Medicare Part B and Part D premiums for T4, T5 and T6 for the following conditions:

### 1. Not Filing SSA-44

2. Filing SSA-44 using T3 MAGI
3. Filing SSA-44 using T4 MAGI
for Iterations 1, Iteration 2, Iteration 3 and Iteration 4 or other possible iterations.

The system determines the savings from filing SSA-44 and using the MAGI of T3 and T4 so that the Medicare beneficiary can pay the least amount of Medicare Part B and Part D premiums. The Medicare beneficiary would then file a SSA-44 and use the years MAGI that will result in the lowest amount of Medicare Part B and Part D Premiums for T4, T5 and T6. If individuals use the wrong years MAGI, it may result in the overpayment of Medicare Part B and Part D premiums. Failure to promptly file SSA-44 may result in the overpayment of Medicare Part B and Part D premiums.

In an example of the system of FIG. 3, the system may be used to perform financial and/or retirement planning for a three year period for an individual. The system also may be used to determine the viability of using the Medicare rules relating to a Life-Changing Event (LCE). As an example for Iteration 1, the system will use the inputs of (a) estimated MAGI for the year T2 (2014)=$110,000, (b) estimated MAGI for the year T3 (2015)=$115,000, (c) estimated MAGI year T4 (2016)=$86,000, for Iteration 2, the system will use the inputs of (d) estimated MAGI for the year T2 (2014)=$110,000, (e) estimated MAGI for the year T3 (2015)=$117,000, (f) estimated MAGI year T4 (2016)=$84,000, for Iteration 3, the system will use the inputs of (g) estimated MAGI for the year T2 (2014)=$165,000, (h) estimated MAGI for the year T3 (2015)=$115,000, (i) estimated MAGI year T4 (2016)=$86,000, for Iteration 4, the system will use the inputs of (j) estimated MAGI for the year T2 (2014)=$165,000, (k) estimated MAGI for the year T3 (2015)=$117,000, (1) estimated MAGI year T4 (2016)=$84,000, (m) months on Part B for the year T4 (2016)=12 months, (n) months on Part D for the year T4 (2016)=12 months, (o) months on Part B for the year T5 (2017)=12 months, (p) months on Part D for the T5 (2017)=12 months, (q) months on Part B for the year T6 (2018)=12 months and (r) months on Part D, for the year T6 (2018)=12 months. The system then determines the Medicare Part B and Part D premiums for T4 (2016), T5 (2017) and T6 (2018) for Iteration 1, Iteration 2, Iteration 3 and Iteration 4.

The system determines the Medicare Part B and Part D premiums for, Iteration 1, T4 (2016) Part B is $2,517.60 and Part D is $373.20, T5 (2017) Part B is $2,517.60 and Part D is $373.20, T6 (2018) Part B is $1,762.80 and Part D is $145.20, Total Part B and Part D for Iteration 1 for T4 (2016), T5 (2017) and T6 (2018) is $7,689.60. For Iteration 2, T4 (2016) Part B is $2,517.60 and Part D is $373.20, T5 (2017) Part B is $2,517.60 and Part D is $373.20, T6 (2018) Part B is $1,258.80 and Part D is $0.00. The total Part B and Part D for Iteration 2 for T4 (2016) T5 (2017) and T6 (2018) is $7,040.40. For Iteration 3, T4 (2016) Part B is $3,272.40 and Part D is $602.40, T5 (2017) Part B is $2,517.60 and Part D is $373.20, T6 (2018) Part B is $1,762.80 and Part D is $145.20. The total Part B and Part D for Iteration 3 for T4 (2016) T5 (2017) and T6 (2018) is $8,673.60. For Iteration 4, T4 (2016) Part B is $3,272.40 and Part D is $602.40, T5 (2017) Part B is $2,517.60 and Part D is $373.20, T6 (2018) Part B is $1,258.80 and Part D is $0.00. The total Part B and Part D for Iteration 4 for T4 (2016) T5 (2017) and T6 (2018) is $8.024.40, The system determines the change in Medicare Part B and Part D premiums between Iterations. For It.2−It.1, T4 (2016) Part B is $0.00 Part D is $0.00, T5 (2017) Part B is $0.00 Part D is $0.00, T6 (2018) Part B is ($504.00) Part D is ($145.20), with a total Part B and Part D difference of ($649.20). For It.3−It.1, T4 (2016) Part B is $754.80 Part D is $229.20, T5 (2017) Part B is $0.00 Part D is $0.00, T6 (2018) Part B is $0.00 Part D is $0.00, with the total Part B and Part D difference of $984.00. For It.3−It.2, T4 (2016) Part B is $754.80 Part D is $229.20, T5 (2017) Part B is $0.00 Part D is $0.00, T6 (2018) Part B is $504.00 Part D is $145.20. The total Part B and Part D difference of $1,633.20. For It.4−It.1, T4 (2016) Part B is $754.80 Part D is $229.20, T5 (2017) Part B is $0.00 Part D is $0.00, T6 (2018) Part B is ($504.00) Part D is ($145.20), for a total Part B and Part D difference of $334.80. For It.4−It.2, T4 (2016) Part B is $754.80 Part D is $229.20, T5 (2017) Part B is $0.00 Part D is $0.00, T6 (2018) Part B is $0.00 Part D is $0.00, for a total Part B and Part D difference of $984.00. For It.4−It.3, T4 (2016) Part B is $0.00 Part D is $0.00, T5 (2017) Part B is $0.00 Part D is $0.00, T6 (2018) Part B is ($504.00) Part D is ($145.20), for a total Part B and Part D difference of ($649.20). The system also determines the change in MAGI by year between iterations. For It.2 It.1, MAGI T2 (2014) is $0.00, MAGI T3 (2015) is $2,000.00, MAGI T4 (2016) is ($2,000.00) and Total MAGI for T2 (2014), T3 (2015) and T4 (2016) is $0.00. For It.3−It.1, MAGI T2 (2014) is $55,000.00, MAGI T3 (2015) is $0.00, MAGI T4 (2016) is $0.00 and Total MAGI for T2 (2014), T3 (2015) and T4 2016) is $55,000.00. For It.3−It.2, MAGI T2 (2014) is $55,000.00, MAGI T3(2015) is ($2,000.00), MAGI T4(2016) is $2,000.00 and Total MAGI for T2(2014), T3(2015) and T4(2016) is $55,000.00. For It.4−It.1, MAGI T2 (2014) is $55,000.00, MAGI T3 (2015) is $2,000.00, MAGI T4 (2016) is ($2,000.00) and Total MAGI for T2 (2014), T3 (2015) and T4 (2016) is $55,000.00. For It.4−It.2, MAGI T2 (2014) is $55,000.00, MAGI T3 (2015) is $0.00, MAGI T4 (2016) is $0.00 and Total MAGI for T2 (2014), T3 (2015) and T4 (2016) is $55,000.00. For It.4−It.3, MAGI T2 (2014) is $0.00, MAGI T3 (2015) is $2,000.00, MAGI T4 (2016) is ($2,000.00) and Total MAGI for T2 (2014), T3 (2015) and T4 (2016) is $0.00. The system demonstrates that the timing of MAGI can result in a change in Medicare Part B and Part D premiums. In this example Iteration 2 has the same MAGI per year and total MAGI for T2 (2014), T3 (2015) and T4 (2016) as Iteration 1 except that $2,000 of MAGI is shifted from T4 (2016) to T3 (2015). This shift of MAGI results in a savings of Medicare Part B premiums of $504.00 and a savings of Medicare Part D premiums of $145.20 with a total Medicare Part B and Part D savings of $649.20 for the year T6 (2018).

The system determines the savings from having a LCE and filing SSA-44 using the MAGI of T3 (2015) and T4 (2016) so that the Medicare beneficiary can pay the least amount of Medicare Part B and Part D premiums in T4 (2016), T5 (2017) and T6 (2018). There is no need to input additional data as the prior input data is used in this part of the system. In this example, the total Medicare Part B and D premiums for T4 (2016), T5 (2017) and T6 (2018), Iteration 1, Not Filing SSA-44 would be $7,689.60. Filing SSA-44 using T3 (2015) MAGI, the Medicare Part B and Part D premiums would be $7,689.60, so there is no savings in Medicare Part B and Part D premiums from filing SSA-44 using T3 (2015) MAGI and SSA-44 would not be filed. Filing SSA-44 using T4 (2016) MAGI, the Medicare Part B and Part D premiums would be $5,724.00, there is $1,965.60 savings in Medicare Part B and Part D premiums from filing SSA-44 using T4 (2016) MAGI and SSA-44 would be filed. In this example, the total Medicare Part B and D premiums for T4 (2016), T5 (2017) and T6 (2018), Iteration 2, Not Filing SSA-44 would be $7,040.40. Filing SSA-44 using T3 (2015) MAGI, the Medicare Part B and Part D premiums would be $7,040.40, there is no savings in Medicare Part B and Part D premiums from filing SSA-44 using T3 (2015) MAGI and SSA-44 would not be filed. Filing SSA-44 using T4 (2016) MAGI, the Medicare Part B and Part D premiums would be $3,776.40, there is $3,264.00 savings in Medicare Part B and Part D premiums from filing SSA-44 using T4 (2016) MAGI and SSA-44 would be filed. In this example, the total Medicare Part B and D premiums for T4 (2016), T5 (2017) and T6 (2018), Iteration 3, Not Filing SSA-44 would be $8,673.60. Filing SSA-44 using T3 (2015) MAGI, the Medicare Part B and Part D premiums would be $7,689.60, so there is a $984.00 savings in Medicare Part B and Part D premiums from filing SSA-44 using T3 (2015) MAGI, and SSA-44 would be filed. Filing SSA-44 using T4 (2016) MAGI, the Medicare Part B and Part D premiums would be $5,724.00, so there is $2,949.60 savings in Medicare Part B and Part D premiums from filing SSA-44 using T4 (2016) MAGI, and SSA-44 would be filed. In Iteration 3 there is savings from filing SSA-44 using the T3 MAGI and using the T4 MAGI but it is important that T4 MAGI is used as it results in $1,965.60 more in Medicare Part B and Part D savings from filing SSA-44. In this example, the total Medicare Part B and D premiums for T4 (2016), T5 (2017) and T6 (2018), Iteration 4, Not Filing SSA-44 would be $8,024.40. Filing SSA-44 using T3 (2015) MAGI, the Medicare Part B and Part D premiums would be $7,040.40, so there is a $984.00 savings in Medicare Part B and Part D premiums from filing SSA-44 using T3 (2015) MAGI, and SSA-44 would be filed. Filing SSA-44 using T4 (2016) MAGI, the Medicare Part B and Part D premiums would be $3,776.40, so there is $4,248.00 savings in Medicare Part B and Part D premiums from filing SSA-44 using T4 (2016) MAGI and SSA-44 would be filed. In Iteration 4 there is savings from filing SSA-44 using the T3 MAGI and using the T4 MAGI, wherein it is noted that when the T4 MAGI is used as it results in $3,264.00 more in Medicare Part B and Part D savings from filing SSA-44. When filing SSA-44, wherein it is noted that when the year's MAGI used is the one that results in the total lowest amount of Medicare Part B and Part D premiums.

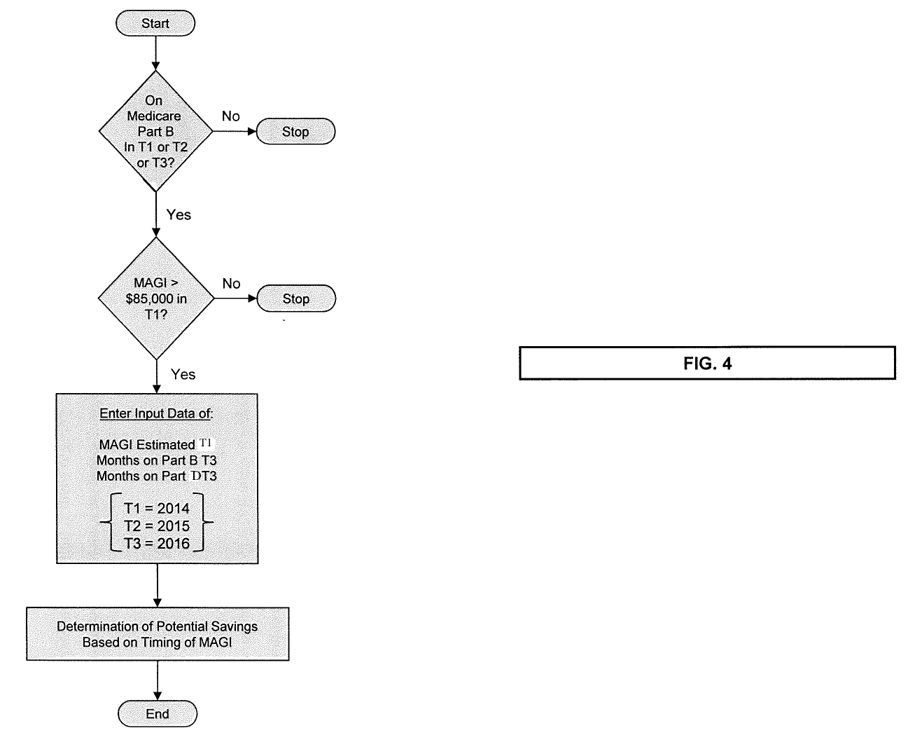

Turning to FIG. 4, the system may provide a one year financial and/or retirement planning system to minimize the Medicare Part B and Part D premiums. In an example, the one year financial and/or retirement planning may be performed for T4 (2016), which is based on the MAGI of T2 (2014). The system is used in T1 (2013) or early in year T2 (2014). Since the MAGI of T2 (2014) determines the Medicare Part B and Part D premium of T4 (2016), the estimated MAGI of T2 (2014) is used as input data. Since the system is future oriented, the Medicare beneficiary can plan and time financial transactions that increase or decrease MAGI to minimize Medicare Part B and Part D premiums in the year T4 (2016).

In an example, the following input data is put into the system for T2 (2014) (a) months on Part B for the year T4 (2016), (b) months on Part D for the year T4 (2016), (c) estimated MAGI for the year T2 (2014) for Circumstance A, (d) estimated MAGI for the year T2 (2014) for Circumstance B, (e) estimated MAGI for the year T2 (2014) for Circumstance C, (f) estimated MAGI for the year T2 (2014) for Circumstance D. Then, the system determines the Medicare Part B, Part D premiums and total Part B and Part D premium for T4 (2016) for Circumstance A, Circumstance B, Circumstance C and Circumstance D. Then, the system determines for Circumstance B−Circumstance A, Circumstance C−Circumstance A, Circumstance C−Circumstance B, Circumstance D−Circumstance A, Circumstance D−Circumstance B and Circumstance D−Circumstance C, the change in MAGI T2 (2014), the change in Part B premium for T4 (2016), the change in Part D premium for T4 (2016), the change in Total Part B and Part D premium for T4 (2016) and the change in Total Part B and Part D premium divided by MAGI, which may be shown as percentages. The system allows the financial and/or retirement planner to do “what if” type computations by including additional or other data from financial transactions into the MAGI for different circumstances to determine the effect of a financial transaction on Medicare Part B and Part D premiums.

As an example of the system of FIG. 4, the system may be used to perform financial and/or retirement planning for a one year period. As an example, (a) months on Part B for the year T4 (2016) for=12 months, (b) months on Part D for the year T4 (2016)=12 months, (c) estimated MAGI for the year T2 (2014) for Circumstance A=$84,900, (d) estimated MAGI for the year T2 (2014) for Circumstance B=$85,001, (e) estimated MAGI for the year T2 (2014) for Circumstance C=$107,000, (f) estimated MAGI for the year T2 (2014) for Circumstance D=$107,001.

The system determines for T4 (2016); Circumstance A the Medicare Part B premium is $1,258.80, the Medicare Part D premium is $0.00 and the Total Medicare Part B and Part D premium is $1,258.80. For Circumstance B, the Medicare Part B premium is $1,762.80, the Medicare Part D premium is $145.20 and the Total Medicare Part B and Part D premium is $1,908.00. For Circumstance C, the Medicare Part B premium is $1,762.80, the Medicare Part D premium is $145.20 and the Total Medicare Part B and Part D premium is $1,908.00, for Circumstance D, the Medicare Part B premium is $2,517.60, the Medicare Part D premium is $373.20 and the Total Medicare Part B and Part D premium is $2,890.80, The system also determines the difference between circumstances, such as (Circumstance B−Circumstance A), MAGI T2 (2014) is $101.00, Part B premium is $504.00, Part D premium $145.20, Total premium is $649.20 and Change B &D/MAGI is 642.77%. For (Circumstance C−Circumstance A), MAGI T2 (2014) is $22,100.00, Part B premium is $504.00, Part D premium $145.20, Total premium is $649.20 and Change B &D/MAGI is 2.94%. For (Circumstance C−Circumstance B), MAGI T2 (2014) is $21,999.00, Part B premium is $0.00, Part D premium $0.00, Total premium is $0.00 and Change B &D/MAGI is 0.00%. For (Circumstance D−Circumstance A), MAGI T2(2014) is $22,101.00, Part B premium is $1,258.80, Part D premium $373.20, Total premium is $1,632.00 and Change B &D/MAGI is 7.38%. For (Circumstance D Circumstance B), MAGI T2 (2014) is $22,000.00, Part B premium is $754.80, Part D premium $228.00, Total premium is $982.80 and Change B &D/MAGI is 4.47%. For (Circumstance D−Circumstance C), MAGI T2 (2014) is $1.00, Part B premium is $754.80, Part D premium $228.00, Total premium is $982.80 and Change B &D/MAGI is 98,280.00%,

The system allows “what if” type changes in MAGI to determine the amount of change in Medicare Part B and Part D premiums. The increase of MAGI of $101.00 of Circumstance B over Circumstance A causes a $649.20 increase in Medicare Part B and Part D premiums. The increase of MAGI of Circumstance B over Circumstance A of $101.00 results in a decrease in disposable income of the $548.20 plus any income tax on the $101.00 of MAGI. The increase of MAGI of $22,100.00 of Circumstance Cover Circumstance A causes a $649.20 increase in Medicare Part B and Part D premiums. A $22,100.00 increase in MAGI in Circumstance C results in the same dollar amount of increase in Medicare Part B and Part D as the $101.00 increase in MAGI of Circumstance B.

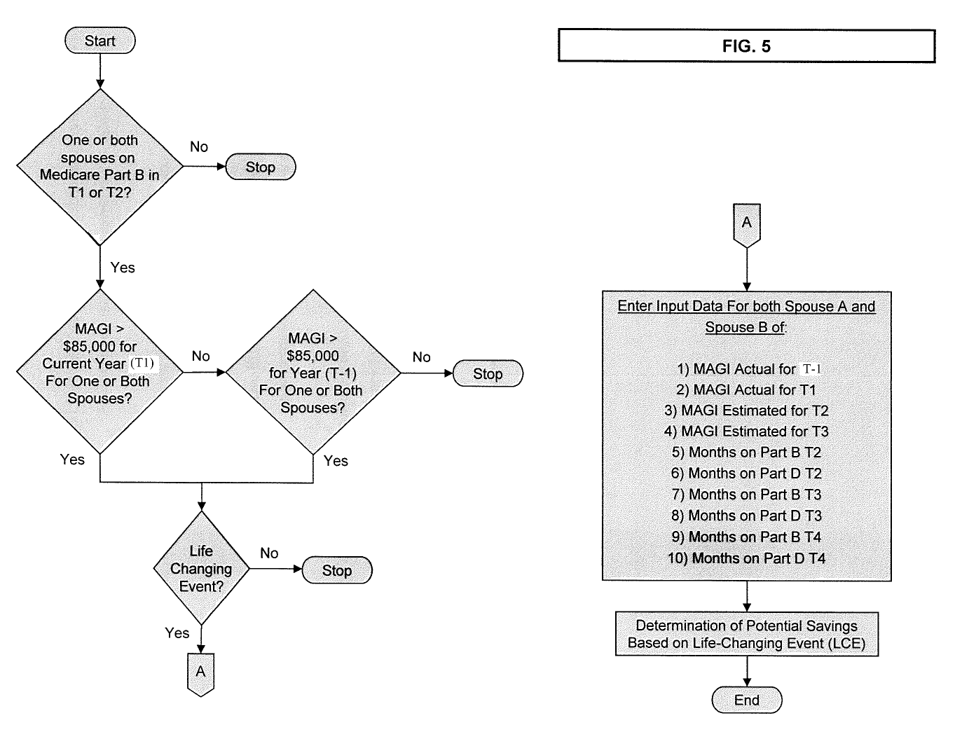

FIG. 5 represents a further example of the system for determining the least cost associated with Medicare Part B and Part D for a married individual that in relation to the possible occurrence of a Life-Changing Event. The system provides for determination of the possible impact of Medicare premium surcharges on an individual, and looks at a period of time in relation to a current year, which may be represented as T1. In the system, the prior year may be represented as T−1, while the next years may be represented as T2, T3 and T4 for example.

If an individual has experienced a Life-Changing Event (LCE), a Form SSA-44 can be elected for the next year (T2). The system may determine the least expensive Medicare benefits based on the occurrence of a LCE. The following input data for both spouse A and spouse B is put into the system: (a) MAGI for the previous year (T−1), (b) MAGI for the current year (T1), (c) MAGI estimated for the next year from the current year (T2), (d) MAGI estimated for the second year from the current year (T3), (e) months on Part B for the next year from the current year (T2), (f) months on Part D for the next year from the current year (T2), (g) months on Part B for the second year from the current year (T3), (h) months on Part D for the second year from the current year (T3), months on Part B for the third year from the current year (T4) and months on Part D for the third year from the current year (T4). Then, the system determines the Medicare Part B and Part D premiums for spouse A and spouse B for filing Married Filing Jointly (MFJ) and Married Filing Separately (MFS) status for T2 using the MAGI of T−1, T1, and T2 to calculate the lowest Medicare Part B and Part D premiums for T2 by filing Form SSA-44, Medicare Income Related Monthly Adjustment Amount Life Changing Event (SSA-44).

According to an example, the system determines the Married Filing Jointly (MFJ) and Married Filing Separately (MFS) Medicare Part B and Part D premiums for T2, T3 and T4 for the following conditions:

### 1. Not Filing SSA-44

2. Filing SSA-44 using T1 MAGI
3. Filing SSA-44 using T2 MAGI
4. Filing SSA-44 using T2 and T3 MAGI

The system determines the savings from filing SSA-44 and using the MAGI of T1, T2 and T2 and T3 so that the Medicare beneficiary can pay the least amount of Medicare Part B and Part D premiums. The Medicare beneficiary would then file a SSA-44 and use the years MAGI that will result in the lowest amount of Medicare Part B and Part D Premiums for T2, T3 and T4. If individuals use the wrong years MAGI, it may result in the overpayment of Medicare Part B and Part D premiums. Failure to promptly file SSA-44 may result in the overpayment of Medicare Part B and Part D premiums.

The system may be used to determine the viability of using the Medicare rules relating to a Life-Changing Event (LCE). As an example, for spouses A and B, the system will use the inputs of a) MAGI for the previous year T−1 (2012) for spouse A=$148,000 and for spouse B=$160,000, (b) MAGI for the current year T1 (2013) for spouse A=$125,000 and for spouse B=$205,000, (c) MAGI estimated for the next year from the current year T2 (2014) for spouse A=$95,000 and for spouse B=$100,000, (d) MAGI estimated for the second year from the current year T3 (2015) for spouse A=$75,000 and for spouse B=$90,000, (e) months on Part B for the next year from the current year T2 (2014) for spouse A=6 months and for spouse B=6 months, (f) months on Part D for the next year from the current year T2 (2014) for spouse A=6 months and for spouse B=6 months, (g) months on Part B for the second year from the current year T3 (2015) for spouse A=12 months and for spouse B=12 months, (h) months on Part D for the second year from the current year T3 (2015) for spouse A=12 months and for spouse B=12 months, (i) months on Part B for the third year from the current year T4 (2016) for spouse A=12 months and for spouse B=12 months and (j) months on Part D for the third year from the current year T4 (2016) for spouse A=12 months and for spouse B=12 months. The system then determines the Married Filing Jointly (MFJ) and Married Filing Separately (MFS) Medicare Part B and Part D premiums for T2 (2014), T3 (2015) and T4 (2016) for the above conditions.

The system determines the savings from filing SSA-44 and using the MAGI of T1 and T2 so that the Medicare beneficiary can pay the least amount of Medicare Part B and Part D premiums in T2 (2014). In this example, the Medicare Part B and D premiums for the couple filing MFJ would be $2,890.80 using T−1 (2012) MAGI, $3,874.80 using T1 (2013) MAGI, $1,908 using T2 (2014). This results in a determination that the couple should not file an SSA-44 form for a LCE using the MAGI for the year T1 (2013), as this would result in no savings of Medicare premiums. But, using the MAGI for T2 (2014), filing the SSA-44 would result in a savings of $982.80 indicating a SSA-44 should be filed. The system also provides the ability to plan ahead using the estimated MAGI for upcoming years under the scenario of filing MFJ, determining the results if the couple were not to file the SSA-44, were to file the SSA-44 using the T1 (2013) MAGI, to file the SSA-44 using the T2 (2014) MAGI and to file the SSA-44 using the T2 (2014) and T3 (2015) MAGI. In this example, the Part B and D premiums for the years T2 (2014)-T4 (2016) were determined for the couple under these different SSA-44 filing possibilities. The results in this example indicate that by not filing the SSA-44, the couple will pay $2,890.80 in T2 (2014), $7,749.60 in T3 (2015) and $3,816.00 in T4 (2016), for a total of $14,456.40. By filing the SSA-44 using the T1 (2013) MAGI, the couple will pay $3,874.80 in T2 (2014), $7,749.60 in T3 (2015) and $3,816.00 in T4 (2016), for a total of $15,440.40. This results in no Medicare Part B and Part D premium savings and indicates the couple should not file SSA-44 under these circumstances. By filing the SSA-44 using the T2 (2014) MAGI, the couple will pay $1,908.00 in T2 (2014), $3,816.00 in T3 (2015) and $3,816.00 in T4 (2016), for a total of $9,540.00. This results in a savings of $4,916.40 and indicates the couple should file SSA-44 under these circumstances. By filing the SSA-44 using the T2 (2014) and T3 (2015) MAGI, the couple will pay $1,908.00 in T2 (2014), $2,517.60 in T3 (2015) and $2,517.60 in T4 (2016), for a total of $6,943.20. This results in a savings of $7,513.20 and indicates the couple should file SSA-44 under these circumstances. The Medicare beneficiary would then file a SSA-44 and use the years MAGI that will result in the lowest amount of Medicare Part B and Part D premiums for T2, T3 and T4. If individuals use the wrong years MAGI, it may result in the overpayment of Medicare Part B and Part D premiums.

In this example, the Medicare Part B and D premiums for the couple filing MFS would be $4,860.00 using T−1 (2012) MAGI, $4,367.40 using T1 (2013) MAGI and $3,874.80 using T2 (2014) MAGI. This results in a determination that the couple should file an SSA-44 form for a LCE using the MAGI for the year T1 (2013), as this would result in savings in Medicare Premiums of $492.60, but using the MAGI of T2 (2014), filing the SSA-44 would result in a savings of $985.20 indicating a SSA-44 should be filed using the T2 (2014) MAGI to pay the least amount of Medicare Part B and Part D premiums in T2 (2014). The system also provides the ability to plan ahead using the estimated MAGI for upcoming years under the scenario of filing MFS, determining the results if the couple were not to file the SSA-44, were to file the SSA-44 using the T1 (2013) MAGI, to file the SSA-44 using the T2 (2014) MAGI and to file the SSA-44 using the T2 (2014) and T3 (2015) MAGI. In this example, the Part B and D premiums for the years T2 (2014)-T4 (2016) were determined for the couple under these different SSA-44 filing possibilities. The results in this example indicate that by not filing the SSA-44, the couple will pay $4,860.0 in T2 (2014), $8,734.80 in T3 (2015) and $7,749.60 in T4 (2016), for a total of $21,344.40. By filing the SSA-44 using the T1 (2013) MAGI, the couple will pay $4,367.40 in T2 (2014), $8,734.80 in T3 (2015) and $7,749.60 in T4 (2016), for a total of $20,851.80. This results in savings of $492.60 and indicates the couple should file SSA-44 under these circumstances. By filing the SSA-44 using the T2 (2014) MAGI, the couple will pay $3,874.80 in T2 (2014), $7,749.60 in T3 (2015) and $7,749.60 in T4 (2016), for a total of $19,374.00. This results in a savings of $1,970.40 and indicates the couple should file SSA-44 under these circumstances. By filing the SSA-44 using the T2 (2014) and T3 (2015) MAGI, the couple will pay $3,874.80 in T2 (2014), $5,133.60 in T3 (2015) and $5,133.60 in T4 (2016), for a total of $14,142.00. This results in a savings of $7,202.40 and indicates the couple should file SSA-44 under these circumstances. The Medicare beneficiary would then file a SSA-44 and use the years MAGI that will result in the lowest amount of Medicare Part B and Part D Premiums for T2, T3 and T4. If individuals use the wrong years MAGI, it may result in the overpayment of Medicare Part B and Part D premiums.

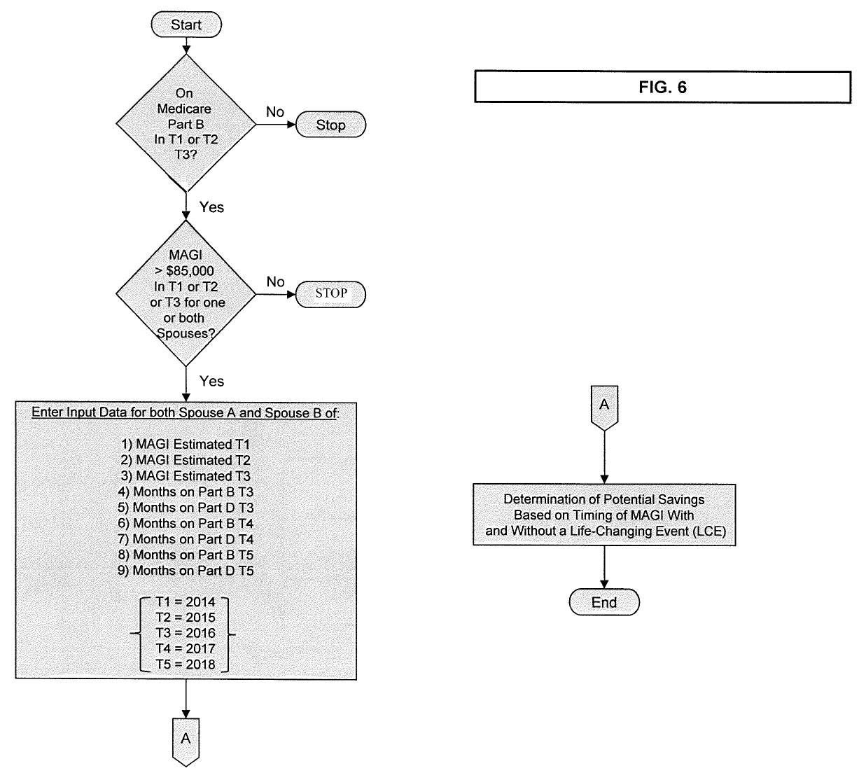

FIG. 6 represents a further example of the system for determining the least cost associated with Medicare Part B and Part D premiums for a three year planning period in association with tax filing status and possible occurrence of a Life-Changing Event for a married individual. The system provides for determination of the possible impact of Medicare premium surcharges on a couple, and looks at a period of time in relation to a current year, which may be represented as T1. In the system, the prior year may be represented as T−1, while the next years may be represented as T2, T3 and T4 for example.

In an example, the current year may be 2013, and T−1 is 2012, while T2=2014, T3=2015, T4=2016, T5=2017 and T6=2018. The system provides a three year financial and/or retirement planning system to determine and minimize the Medicare Part B and Part D premiums for T4 (2016), T5 (2017) and T6 (2018) that is used in T1 (2013) or early in year T2 (2014). Since the MAGI of T2 (2014) determines the Medicare Part B and Part D premium of T4 (2016), the MAGI of T3 (2015) determines the Medicare Part B and Part D premium of T5 (2017) and the MAGI of T4 (2016) determines the Medicare Part B and Part D premium of T6 (2018), the system uses the estimated MAGI of T2 (2014), T3 (2015) and T4 (2016) as inputs. Since the system is future oriented, the Medicare beneficiaries can plan and time financial transactions that increase or decrease MAGI between years to minimize Medicare Part B and Part D premiums in the future. The system has two major components, financial and/or retirement planning without a Life-Changing Event (LCE) and financial and/or retirement planning with a Life-Changing Event. The system without a Life-Changing Event is first described. The following input data for both Spouse A and Spouse B is put into the system for one or more iterations: (a) estimated MAGI for the T2 (2014), (b) estimated MAGI for the year T3 (2015), (c) estimated MAGI for the year T4 (2016), (d) months on Part B for the year T4 (2016), (e) months on Part D for the year T4 (2016), (f) months on Part B for the year T5 (2017), (g) months on Part D for the year T5 (2017), (h) months on Part B for T6 (2018) and (i) months on Part D for T6 (2018). Then, the system determines the Medicare Part B and Part D premiums for spouse A and spouse B for filing Married Filing Jointly (MFJ) and Married Filing Separately (MFS) status for T4 (2016), T5 (2017) and T6 (2018). The system allows the financial and/or retirement planner to do “what if” type computations by including additional or other data from financial transactions into the MAGI for iterations, such as Iteration One and Two, to determine the effect of a financial transaction on Medicare Part B and Part D premiums. The system determines for each iteration and each year the difference between MFS and MFJ and determines the income tax filing status with the lowest total Medicare Part B and Part D premiums. The system determines the difference between Iteration 2 and Iteration 1 to determine the change in MAGI between the iterations and also determines the change in Medicare Part B and Part D premiums. This demonstrates that for a change in MAGI from Iteration One to Iteration Two, the amount of change in Medicare Part B and Part D premiums filing MFS and MFJ.

Significant savings in Medicare Part B and Part D premiums could occur when an individual has or will experience a Life-Changing Event (LCE) and files a Form SSA-44. Some LCEs can be planned for such as work stoppage or reduction. The system has a second component that determines the Medicare Part B and Part D premiums with a LCE. This component of the system uses that input data from above and requires no additional input data. If an individual will or does experience a Life-Changing Event (LCE), a Form SSA-44 can be elected. The system determines the least expensive Medicare Part B and Part D premiums based on the LCE. Then, the system determines the Medicare Part B and Part D premiums for spouse A and spouse B for filing Married Filing Jointly (MFJ) and Married Filing Separately (MFS) status for T4, T5 and T6 using the MAGI of T2, T3, and T4 to calculate the lowest Medicare Part B and Part D premiums by filing Form SSA-44, Medicare Income Related Monthly Adjustment Amount Life Changing Event (SSA-44). The system determines the Married Filing Jointly (MFJ) and Married Filing Separately (MFS) Medicare Part B and Part D premiums for T4, T5 and T6 for the following conditions:

### 1. Not Filing SSA-44

2. Filing SSA-44 using T3 (2015) MAGI
3. Filing SSA-44 using T4 (2016) MAGI

The system determines the savings from filing SSA-44 and using the MAGI of T3 and T4 so that the Medicare beneficiary can pay the least amount of Medicare Part B and Part D premiums. The Medicare beneficiary would then file a SSA-44 and use the years MAGI that will result in the lowest amount of Medicare Part B and Part D Premiums for T4, T5 and T6. If individuals use the wrong years MAGI, it may result in the overpayment of Medicare Part B and Part D premiums. Failure to promptly file SSA-44 may result in the overpayment of Medicare Part B and Part D premiums.

The system may be used to perform financial and/or retirement planning for a three year period. The system also may be used in conjunction with or separately to determine the viability of using the Medicare rules relating to a Life-Changing Event (LCE). As an example for Iteration One, for spouses A and B, the system will use the inputs of a) estimated MAGI for the year T2 (2014) for spouse A=$132,000 and for spouse B=$90,000, (b) estimated MAGI for the year T3 (2015) for spouse A=$140,000 and for spouse B=$95,000, (c) estimated MAGI year T4 (2016) for spouse A=$90,000 and for spouse B=$86,000, (d) months on Part B for the year T4 (2016) for spouse A=12 months and for spouse B=12 months, (e) months on Part D for the year T4 (2016) for spouse A=12 months and for spouse B=12 months, (f) months on Part B for the year T5 (2017) for spouse A=12 months and for spouse B=12 months, (g) months on Part D for the T5 (2017) for spouse A=12 months and for spouse B=12 months, (h) months on Part B for the year T6 (2018) for spouse A=12 months and for spouse B=12 months and (i) months on Part D, for the year T6 (2018) for spouse A=12 months and for spouse B=12 months. The system then determines the Married Filing Jointly (MFJ) and Married Filing Separately (MFS) Medicare Part B and Part D premiums for T4 (2016), T5 (2017) and T6 (2018) for Iteration One. Iteration Two only requires additional MAGI data. As an example for Iteration Two, for spouses A and B, the system will use the inputs of a) estimated MAGI for the year T2 (2014) for spouse A=$132,000 and for spouse B=$90,000, (b) estimated MAGI for the year T3 (2015) for spouse A=$146,000 and for spouse B=$97,000, (c) estimated MAGI year T4 (2016) for spouse A=$84,000 and for spouse B=$84,000.

The system determines the Medicare Part B and Part D premiums for T4 (2016), Iteration One MFJ for Spouse A is $2,890.80, for Spouse B is $2,890.80 and a total premium for both spouses of $5,781.60, MFS for Spouse A is $4,860.00, for Spouse B is $3,874.80 and a total premium of $8,734.80. The system determines the difference of (MFS−MFJ) and indicates the filing status that results in the lowest Medicare Part B and Part D premium. For Spouse A the difference is $1,969.20 and this is saved by filing MFJ. For Spouse B the difference is $984.00 and this is saved by filing MFJ. For the married couple the difference is $2,953.20 and this is saved by filing MFJ. The system determines the Medicare Part B and Part D premiums for T4(2016), Iteration Two MFJ for Spouse A is $2,890.80, for Spouse B is $2,890.80 and a total premium for both spouses of $5,781.60, MFS for Spouse A is $4,860.00, for Spouse B is $3,874.80 and a total premium of $8,734.80. The system determines the difference of (MFS−MFJ) and indicates the filing status that results in the lowest Medicare Part B and Part D premium. For Spouse A the difference is $1,969.20 and this is saved by filing MFJ. For Spouse B the difference is $984.00 and this is saved by filing MFJ. For married couple the difference is $2,953.20 and this is saved by filing MFJ. The system may also determine the difference (IT2−IT1) for Spouse A, Spouse B and the total for both spouses for MAGI, MFJ Part B and Part D premiums and MFS Part B and Part D premiums and in this example for T4(2016) the differences are zero.

The system determines the Medicare Part B and Part D premiums for T5 (2017), Iteration One MFJ for Spouse A is $2,890.80, for Spouse B is $2,890.80 and a total premium for both spouses of $5,781.60, MFS for Spouse A is $4,860.00, for Spouse B is $3,874.80 and a total premium of $8,734.80. The system determines the difference of (MFS−MFJ) and indicates the filing status that results in the lowest Medicare Part B and Part D premium. For Spouse A the difference is $1,969.20 and this is saved by filing MFJ. For Spouse B the difference is $984.00 and this is saved by filing MFJ. For the married couple the difference is $2,953.20 and this is saved by filing MFJ. The system determines the Medicare Part B and Part D premiums for T5 (2017), Iteration Two MFJ for Spouse A is $2,890.80, for Spouse B is $2,890.80 and a total premium for both spouses of $5,781.60, MFS for Spouse A is $4,860.00, for Spouse B is $3,874.80 and a total premium of $8,734.80. The system determines the difference of (MFS−MFJ) and indicates the filing status that results in the lowest Medicare Part B and Part D premium. For Spouse A the difference is $1,969.20 and this is saved by filing MFJ. For Spouse B the difference is $984.00 and this is saved by filing MFJ. For the married couple the difference is $2,953.20 and this is saved by filing MFJ. The system also determines the difference (IT2−IT1) for Spouse A, Spouse B and the total for both spouses for MAGI, MFJ Part B and Part D premiums and MFS Part B and Part D premiums. In this example for T5 (2017) the MAGI of Spouse A is increased by $6,000.00 and the MAGI of Spouse B is increased by $2,000.00 and a total increase in MAGI of $8,000.00, with no change in MFJ Medicare Part B and Part D premiums and with no change in MFS Medicare Part B and Part D premiums. The system determines the Medicare Part B and Part D premiums for T6 (2018), Iteration One MFJ for Spouse A is $1,908.00, for Spouse B is $1,908.00 and a total premium for both spouses of $3,816.00, MFS for Spouse A is $3,874.80, for Spouse B is $3,874.80 and a total premium of $7,749.60. The system determines the difference of (MFS−MFJ) and indicates the filing status that results in the lowest Medicare Part B and Part D premium. For Spouse A the difference is $1,966.80 and this is saved by filing MFJ. For Spouse B the difference is $1,966.80 and this is saved by filing MFJ. For married couple the difference is $3,933.60 and this is saved by filling MFJ. The system determines the Medicare Part B and Part D premiums for T6 (2018), Iteration Two MFJ for Spouse A is $1,258.80, for Spouse B is $1,258.80 and a total premium for both spouses of $2,517.60, MFS for Spouse A is $1,258.80, for Spouse B is $1,258.800 and a total premium of $2,517.60. The system determines the difference of (MFS−MFJ) and indicates the filing status that results in the lowest Medicare Part B and Part D premium. For Spouse A the difference is zero and the Medicare Part B and Part D premium are the same for filing MFS or MFJ. For Spouse B the difference is zero and the Medicare Part B and Part D premium are the same for filing MFS or MFJ. For the married couple the difference is zero and the Medicare Part B and Part D are the same for filing MFS or MFJ. The system also determines the difference (IT2−IT1) for Spouse A, Spouse B and the total for both spouses for MAGI, MFJ Part B and Part D premiums and MFS Part B and Part D premiums. In this example for T6 (2018) the MAGI of Spouse A is decreased by $6,000.00 and the MAGI of Spouse B is decreased by $2,000.00 and a total decrease in MAGI of $8,000.00, with a decrease in MFJ Medicare Part B and Part D premiums of $649.20 for Spouse A and with a decrease in MFJ Medicare Part B and Part D premiums of $649.20 for Spouse B for a total decrease in MFJ Medicare Part B and Part D premiums of $1,298.40. There is a decrease in MFS Medicare Part B and Part D premiums of $2,616.00 for Spouse A and with a decrease in MFS Medicare Part B and Part D premiums of $2,616.00 for Spouse B for a total decrease in MFS Medicare Part B and Part D premiums of $5,232.00. Transferring $6,000 of MAGI for Spouse A from T4 (2016) to T3 (2015) saves Spouse A $649.20 filing MFJ and saves Spouse A $2,616.00 filing MFS. Transferring $2,000 of MAGI for Spouse B from T4 (2016) to T3 (2015) saves Spouse B $649.20 filing MFJ and saves Spouse B $2,616.00 filing MFS. The “shifting/transfer” of $8,000.00 MAGI from T4 (2016) to T3 (2015) reduces the Medicare Part B and Part D premiums by $1,298.40 when filing MFJ and by $5,232.00 when filing MFS.

The second part of the system may again be used to determine the viability of using the Medicare rules relating to a Life-Changing Event (LCE) in financial and/or retirement planning for T2 (2014), T3 (2015) and T4 (2016) to pay the least amount of Medicare Part B and Part D premiums in T4 (2016), T5 (2017) and T6 (2018). The system determines the Married Filing Jointly (MFJ) and Married Filing Separately (MFS) Medicare Part B and Part D premiums for T4 (2016), T5 (2017) and T6 (2018) for the following conditions:

### 1. Not Filing SSA-44

2. Filing SSA-44 using T3 (2015) MAGI
3. Filing SSA-44 using T4 (2016) MAGI

The system determines the savings from filing SSA-44 and using the MAGI of T3 (2015) and T4 (2016) so that the Medicare beneficiary can pay the least amount of Medicare Part B and Part D premiums in T4 (2016), T5 (2017) and T6 (2018). There is no need to input additional data as the prior input data is used in this part of the system.

In this example, the Medicare Part B and D premiums for the couple filing MFJ for Iteration One, Not Filing SSA-44 would be $5,781.60 for T4 (2016), $5,781.60 for T5 (2017) and $3,816.00 for T6 (2018) for a three year total of $15,379.20. Filing SSA-44 using T3 (2015) MAGI, the Medicare Part B and Part D premiums would be $5,781.60 for T4 (2016), $5,781.60 for T5 (2017) and $3,816.00 for T6 (2018) for a three year total of $15,379.20. There is no savings in Medicare Part B and Part D premiums from filing SSA-44 using T3 (2015) MAGI, and SSA-44 would not be filed. Filing SSA-44 using T4 (2016) MAGI, the Medicare Part B and Part D premiums would be $3,816.00 for T4 (2016), $3,816.00 for T5 (2017) and $3,816.00 for T6 (2018) for a three year total of $11,448.00. There is $3,931.20 savings in Medicare Part B and Part D premiums from filing SSA-44 using T4 (2016) MAGI and SSA-44 would be filed.

In this example, the Medicare Part B and D premiums for the couple filing MFJ for Iteration Two, Not Filing SSA-44 would be $5,781.60 for T4 (2016), $5,781.60 for T5 (2017) and $2,517.60 for T6 (2018) for a three year total of $14,080.80. Filing SSA-44 using T3 (2015) MAGI, the Medicare Part B and Part D premiums would be $5,781.60 for T4 (2016), $5,781.60 for T5 (2017) and $2,517.60 for T6 (2018) for a three year total of $14,080.80. There is no savings in Medicare Part B and Part D premiums from filing SSA-44 using T3 (2015) MAGI and SSA-44 would not be filed. Filing SSA-44 using T4 (2016) MAGI, the Medicare Part B and Part D premiums would be $2,517.60 for T4 (2016), $2,517.60 for T5 (2017) and $2,517.60 for T6 (2018) for a three year total of $7,552.80. There is $6,528.00 savings in Medicare Part B and Part D premiums from filing SSA-44 using T4 (2016) MAGI and SSA-44 would be filed.

Comparing Iteration One with Iteration Two for filing MFJ, the $8,000 “shift/transfer” ($6,000 for Spouse A and $2,000 for Spouse B) of MAGI from T4 (2016) to T3 (2015) caused a $1,298.40 reduction in Medicare Part B and Part D premiums for the three year period (T4, T5 and T6) when Not Filing SSA-44. Comparing Iteration One with Iteration Two, the $8,000 “shift/transfer” ($6,000 for Spouse A and $2,000 for Spouse B) of MAGI from T4 (2016) to T3 (2015) caused a $1,298.40 reduction in Medicare Part B and Part D premiums for the three year period (T4, T5 and T6) when Filing SSA-44 Using 2015 MAGI. In Iteration One, Not Filing SSA-44 results in total Medicare Part B and Part D premiums for the three years of $15,379.20 and Filing SSA-44 Using 2016 MAGI results in Medicare Part B and Part D premiums of $11,448.00 which is a savings of $3,931.20 from filing SSA-44. Iteration Two “shifts/transfers” $6,000 of MAGI of Spouse A and $2,000 of MAGI of Spouse B from T4 (2016) to T3 (2015). This results in a $1,298.40 savings in Medicare Part B and Part D premiums with Not Filing SSA-44. In Iteration Two, the Medicare Part B and Part Premiums for Not Filing SSA-44 are $14,080.80 and for Filing SSA-44 Using T4 (2016) MAGI is $7,552.80. This is a savings of $6,528.00 from filing SSA-44. In Iteration One Not Filing SSA-44 the total premium is $15,379.20 and in Iteration Two Filing SSA-44 Using T4 (2016) MAGI the total premium is $7,552.80 with a total difference of $7,826.40. The total difference of $7,826.40 is made up of $1,298.40 from the “shift/transfer” of $8,000 MAGI from T4 (2016) to T3 (2015), while $6,528.00 is from filling SSA-44 Using T4 (2016) MAGI.

In this example, the Medicare Part B and D premiums for the couple filing MFS for Iteration One, Not Filing SSA-44 would be $8,734.80 for T4 (2016), $8,734.80 for T5 (2017) and $7,749.60 for T6 (2018) for a three year total of $25,219.20. Filing SSA-44 using T3 (2015) MAGI, the Medicare Part B and Part D premiums would be $8,734.80 for T4 (2016), $8,734.80 for T5 (2017) and $7,749.60 for T6 (2018) for a three year total of $25,219.20. There is no savings in Medicare Part B and Part D premiums from filing SSA-44 using T3 (2015) MAGI and SSA-44 would not be filed. Filing SSA-44 using T4 (2016) MAGI, the Medicare Part B and Part D premiums would be $7,749.60 for T4 (2016), $7,749.60 for T5 (2017) and $7,749.60 for T6 (2018) for a three year total of $23,248.80. There is $1,970.40 savings in Medicare Part B and Part D premiums from filing SSA-44 using T4 (2016) MAGI and SSA-44 would be filed.

In this example, the Medicare Part B and D premiums for the couple filing MFS for Iteration Two, Not Filing SSA-44 would be $8,734.80 for T4 (2016), $8,734.80 for T5 (2017) and $2,517.60 for T6 (2018) for a three year total of $19,987.20. Filing SSA-44 using T3 (2015) MAGI, the Medicare Part B and Part D premiums would be $8,734.80 for T4 (2016), $8,734.80 for T5 (2017) and $2,517.60 for T6 (2018) for a three year total of $19,987.20. There is no savings in Medicare Part B and Part D premiums from filing SSA-44 using T3 (2015) MAGI and SSA-44 would not be filed. Filing SSA-44 using T4 (2016) MAGI, the Medicare Part B and Part D premiums would be $2,517.60 for T4 (2016), $2,517.60 for T5 (2017) and $2,517.60 for T6 (2018) for a three year total of $7,552.80. There is $12,434.40 savings in Medicare Part B and Part D premiums from filing SSA-44 using T4 (2016) MAGI and SSA-44 would be filed.

Comparing Iteration One with Iteration Two when filing MFS, the $8,000 “shift/transfer” ($6,000 for Spouse A and $2,000 for Spouse B) of MAGI from T4 (2016) to T3 (2015) caused a $5,232.00 reduction in Medicare Part B and Part D premiums for the three year period (T4, T5 and T6) when Not Filing SSA-44. Comparing Iteration One with Iteration Two, the $8,000 “shift/transfer” ($6,000 for Spouse A and $2,000 for Spouse B) of MAGI from T4 (2016) to T3 (2015) caused a $5,232.00 reduction in Medicare Part B and Part D premiums for the three year period (T4, T5 and T6) when Filing SSA-44 Using 2015 MAGI. In Iteration One, Not Filing SSA-44 results in total Medicare Part B and Part D premiums for the three years of $25,219.20 and Filing SSA-44. Using T4 (2016) MAGI results in Medicare Part B and Part D premiums of $23,248.80 which is a savings of $1,970.40 from filing SSA-44. Iteration Two “shifts/transfers” $6,000 of MAGI of Spouse A and $2,000 of MAGI of Spouse B from T4 (2016) to T3 (2015). This results in a $5,232.00 savings in Medicare Part B and Part D premiums with Not Filing SSA-44. In Iteration Two, the Medicare Part B and Part Premiums for Not Filing SSA-44 are $19,987.20 and for Filing SSA-44. Using 2016 MAGI is $7,552.80. This is a savings of $12,434.40 from filing SSA-44. In Iteration One Not Filing SSA-44 the total premium is $25,219.20 and in Iteration Two Filing SSA-44 Using T4 (2016) MAGI the total premium is $7,552.80 with a total difference of $17,666.40. The total difference of $17,666.40 is made up of $5,232.00 from the “shift/transfer” of $8,000 MAGI from T4 (2016) to T3 (2015), while $12,434.40 is from filling SSA-44 Using T4 (2016) MAGI.

The Medicare beneficiary would then file a SSA-44 and use the years MAGI that will result in the lowest amount of Medicare Part B and Part D Premiums for T2, T3 and T4. If individuals use the wrong years MAGI, it may result in the overpayment of Medicare Part B and Part D premiums.

As mentioned previously, there may also be the opportunity to “shift” future MAGI into the current year or future year to avoid paying the maximum IRMAA in a given year. For example, a single person may be able shift income from one year to another to reduce the surcharge in a given year. For married individuals, with two filing statuses (MFJ and MFS) for married couples and four IRMAA MAGI ranges for MFJ and two IRMAA MAGI ranges for MFS, there are many opportunities to “shift” MAGI between years and spouses to reduce the Medicare Part B and Part D IRMAA surcharges. The system allows the user to easily do “what if” type planning computations for the complexities for married individuals who have two filing statuses with six IRMAA ranges of which several overlap.

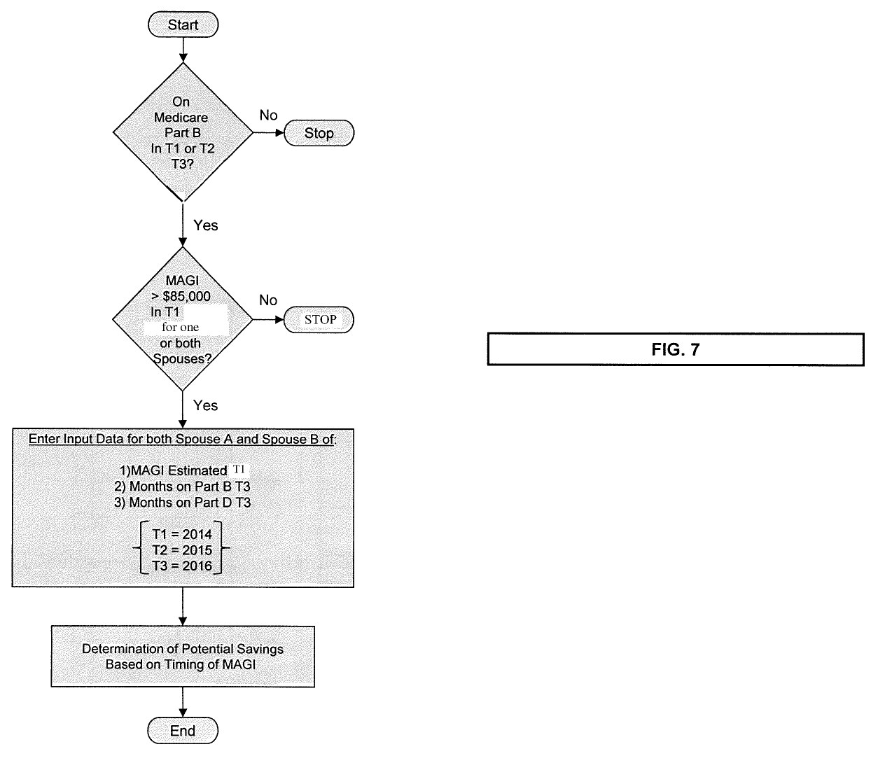

FIG. 7 represents an example of the system in accordance with the invention for determining the least cost associated with Medicare Part B and Part D premiums for a one year planning period for a married couple.

In this example, the system provides for determination of the possible impact of Medicare premium surcharges on a couple. The system is a one year financial and/or retirement planning system to determine and minimize the Medicare Part B and Part D premiums for T4 (i.e. 2016) which is based on the MAGI of T2 (2014). The system is used in T1 (2013) or early in year T2 (2014). Since the MAGI of T2 (2014) determines the Medicare Part B and Part D premium of T4 (2016), the estimated MAGI of T2 (2014) is used as inputs. Since the system is future oriented, the Medicare beneficiaries can plan and time financial transactions that increase or decrease MAGI to minimize Medicare Part B and Part D premiums in the year T4 (2016). Iterations may be performed to evaluate different possible scenarios.

The following inputs for both Spouse A and Spouse B is put into the system for Iteration One: (a) estimated MAGI for the T2 for Alternative A, (b) estimated MAGI for the T2 for Alternative B, (c) months on Part B for the year T4, (d) months on Part D for the year T4; for Iteration Two: (e) estimated MAGI for the T2 for Alternative A, (f) estimated MAGI for the T2 for Alternative B. Then, the system determines the Medicare Part B and Part D premiums for spouse A and spouse B for filing Married Filing Jointly (MFJ) and Married Filing Separately (MFS) status for T4 for Alternative A and Alternative B in Iteration One and for Alternative A and Alternative B in Iteration Two. The system allows the financial and/or retirement planner to do “what if” type computations by including additional or other data from financial transactions into the MAGI for Iteration Two to determine the effect of a financial transaction on Medicare Part B and Part D premiums. Then, the system determines for Iteration One, Alternative A and Alternative B and Iteration Two, Alternative A and Alternative B the Medicare Part B and Part D premiums for spouse A and spouse B for filing Married Filing Jointly (MFJ) and Married Filing Separately (MFS) status for T4 (2016). The system determines the Medicare Part B and Part D premiums for Spouse A and Spouse B and the total Part B and Part D premiums for the couple filing MFJ and MFS for T4. The system determines for each Alternative the difference between MFS and MFJ and determines the income tax filing status with the lowest total Medicare Part B and Part D premiums. The system determines the difference between Iteration Two and Iteration One to determine the change in MAGI between the iterations and also determines the change in Medicare Part B and Part D premiums. This demonstrates that for a change in MAGI from Iteration One to Iteration Two, the amount of change in Medicare Part B and Part D premiums filing MFS and MFJ. The system determines the difference between Alternative B less Alternative A to determine the change in MAGI between the alternatives and also determines the corresponding change in Medicare Part B and Part D premiums. This demonstrates that for a change in MAGI from Alternative A to Alternative B, the amount of change in Medicare Part B and Part D premiums filing MFS and MFJ.

The system may be used to perform financial and/or retirement planning for a one year period. As an example for Iteration One, for spouses A and B, the system will use the inputs of (a) estimated MAGI for the year T2 (2014) for Alternative A for spouse A=$85,000 and for spouse B=$84,000, (b) estimated MAGI for the year T2 (2014) for Alternative B for spouse A=$85,500 and for spouse B=$83,500, (c) months on Part B for the year T4 (2016) for spouse A=12 months and for spouse B=12 months, (d) months on Part D for the year T4 (2016) for spouse A=12 months and for spouse B=12 months, for Iteration Two, for spouses A and B, the system will use the inputs of (e) estimated MAGI for the year T2 (2014) for Alternative A for spouse A=$87,000 and for spouse B=$84,000, (f) estimated MAGI for the year T2 (2014) for Alternative B for spouse A=$85,500 and for spouse B=$85,500.

The system determines the Medicare Part B and Part D premiums for T4 (2016), Iteration One, Alternative A, MFJ for Spouse A is $1,258.80, for Spouse B is $1,258.80 and a total premium for both spouses of $2,517.60, MFS for Spouse A is $1,258.80, for Spouse B is $1,258.80 and a total premium of $2,517.60. The system determines the difference of (MFS−MFJ) and indicates the filing status that results in the lowest Medicare Part B and Part D premium. For Spouse A the difference is zero and the Medicare Part B and Part D premiums are the same for filing MFS or MFJ. For Spouse B the difference is zero and the Medicare Part B and Part D premiums are the same for filing MFS or MFJ. For the married couple the difference is zero and the Medicare Part B and Part D premiums are the same for filing MFS or MFJ. For T4(2016), Iteration One, Alternative B, MFJ for Spouse A is $1,258.80, for Spouse B is $1,258.80 and a total premium for both spouses of $2,517.60, MFS for Spouse A is $3,874.80, for Spouse B is $1,258.80 and a total premium of $5,133.60. The system determines the difference of (MFS−MFJ) and indicates the filing status that results in the lowest Medicare Part B and Part D premium. For Spouse A the difference is $2,616.00 and this is saved by filing MFJ. For Spouse B the difference is zero and the Medicare Part B and Part D premiums are the same for filing MFS or MFJ. For the married couple the difference is $2,616.00 and this is saved by filing MFJ. The system also determines the difference (Alternative B−Alternative A) for Spouse A, Spouse B and the total for both spouses for MAGI, MFJ Part B and Part D premiums and MFS Part B and Part D premiums. In this example for T2 (2014) the MAGI of Spouse A is increased by $500.00 and the MAGI of Spouse B is decreased by $500.00 with a total increase in MAGI of zero. For Spouse A filing MFJ, the difference in Medicare Part B and Part D premiums is zero. For Spouse B filing MFJ, the difference in Medicare Part B and Part D premiums is zero. The couple filing MFJ has a difference in Medicare Part B and Part D premiums of zero. For Spouse A filing MFS, the difference in Medicare Part B and Part D premiums is an increase of $2,616.00. For Spouse B filing MFS, the difference in Medicare Part B and Part D premiums is zero. The couple filing MFS has a difference in Medicare Part B and Part D premiums of an increase of $2,616.00. The “transferring/shifting” of $500.00 of MAGI from Spouse B to Spouse A in Alternative B cause no change in Medicare Part B and Part D premiums when filing MFJ, but caused an increase in Medicare Part B and Part D premiums when filing MFS of $2,616.00.

The system determines the Medicare Part B and Part D premiums for T4 (2016), Iteration Two, Alternative A, MFJ for Spouse A is $1,908.00, for Spouse B is $1,908.00 and a total premium for both spouses of $3,816.00, MFS for Spouse A is $3,874.80, for Spouse B is $1,258.80 and a total premium of $5,133.60. The system determines the difference of (MFS−MFJ) and indicates the filing status that results in the lowest Medicare Part B and Part D premium. For Spouse A the difference is $1,966.80 and the Medicare Part B and Part D premiums are minimized by filing MFJ. For Spouse B the difference is $(649.20) and the Medicare Part B and Part D premiums are minimized by filing MFS. For the married couple the difference is $1,317.60 and the Medicare Part B and Part D premiums are minimized by filing MFJ. For T4(2016), Iteration Two, Alternative B, MFJ for Spouse A is $1,908.00, for Spouse B is $1,908.00 and a total premium for both spouses of $3,816.00, MFS for Spouse A is $3,874.80, for Spouse B is $3,874.80 and a total premium of $7,749.60. The system determines the difference of (MFS−MFJ) and indicates the filing status that results in the lowest Medicare Part B and Part D premium. For Spouse A the difference is $1,966.80 and this is saved by filing MFJ. For Spouse B the difference is $1,966.80 and this is saved by filing MFJ. For the married couple the difference is $3,933.60 and this is saved by filing MFJ. The system also determines the difference (Alternative B−Alternative A) for Spouse A, Spouse B and the total for both spouses for MAGI, MFJ Part B and Part D premiums and MFS Part B and Part D premiums. In this example for T2 (2014) the MAGI of Spouse A is decreased by $1,500.00 and the MAGI of Spouse B is increased by $1,500.00 with a total increase in MAGI of zero. For Spouse A filing MFJ, the difference in Medicare Part B and Part D premiums is zero. For Spouse B filing MFJ, the difference in Medicare Part B and Part D premiums is zero. The couple filing MFJ has a difference in Medicare Part B and Part D premiums of zero. For Spouse A filing MFS, the difference in Medicare Part B and Part D premiums is zero. For Spouse B filing MFS, the difference in Medicare Part B and Part D premiums is an increase of $2,616.00. The couple filing MFS has a difference in Medicare Part B and Part D premiums of an increase of $2,616.00. The “transferring/shifting” of $1,500.00 of MAGI from Spouse A to Spouse B in Alternative B cause no change in Medicare Part B and Part D premiums when filing MFJ, but caused an increase in Medicare Part B and Part D premiums when filing MFS of $2,616.00.

The system also determines the difference (Iteration Two−Iteration One) for the Alternative A and Alternative B for Spouse A, Spouse B and the total for both spouses for MAGI, MFJ Part B and Part D premiums and MFS Part B and Part D premiums. In this example for Alternative A, T2 (2014) the MAGI of Spouse A is increased by $2,000.00 and the MAGI of Spouse B is increased by zero with a total increase in MAGI of $2,000.00. For Spouse A filing MFJ, the Medicare Part B and Part D premiums is increased by $649.20. For Spouse B filing MFJ, the Medicare Part B and Part D premiums is increased by $649.20. The couple filing MFJ has an increase in Medicare Part B and Part D premiums of $1,298.40. For Spouse A filing MFS, the Medicare Part B and Part D premiums is increased by $2,616.00. For Spouse B filing MFS, the Medicare Part B and Part D premiums has no increase. The couple filing MFS has an increase in Medicare Part B and Part D premiums of $2,616.00. In Iteration Two, Alternative A, an increase in MAGI of $2,000 for Spouse A causes an increase in Medicare Part B and Part D premiums of $649.20 for Spouse A and $649.20 for Spouse B when filing MFJ for a total increase for the couple of $1,298.40. Filing MFS causes Spouse A an increase in Medicare Part B and Part D premiums of $2,616.00 and no increase in Spouse B Medicare Part B and Part D premiums for a total increase for the couple of $2,616.00. The system demonstrates that if the couple will file as MFS, they should not increase their MAGI by $2,000 for Spouse A as this results in a decrease in disposable income by $616.00 because of the additional Medicare Part B and Part D premiums. The system also demonstrates that if the couple will file as MFJ, they have a $1,298.40 increase in Medicare Part B and Part D premiums from a $2,000 increase in MAGI and that they will give approximately 65% of the increase MAGI to Medicare. Sometimes making more MAGI can actually result in less disposable income. If the couple filing MFS were to not make the additional MAGI of $2,000, they would have $616.00 more in disposable income. In this example for Alternative B, T2 (2014) the MAGI of Spouse A is unchanged and the MAGI of Spouse B is increased by $2,000.00 with a total increase in MAGI of $2,000.00. For Spouse A filing MFJ, the Medicare Part B and Part D premiums is increased by $649.20. For Spouse B filing MFJ, the Medicare Part B and Part D premiums is increased by $649.20. The couple filing MFJ has an increase in Medicare Part B and Part D premiums of $1,298.40. For Spouse A filing MFS, the Medicare Part B and Part D premiums has no change. For Spouse B filing MFS, the Medicare Part B and Part D premiums has is increased by $2,616.00. The couple filing MFS has an increase in Medicare Part B and Part D premiums of $2,616.00. Adding $2,000 of MAGI in Iteration Two of Alternative B resulted in an increase in the Medicare Part B and Part D premiums of $1,298.40 when filing MFJ and an increase in Medicare Part B and Part D premiums of $2,616.00 when filing MFS. Sometimes making more MAGI can actually result in less disposable income. If the couple filing MFS were to not make the additional MAGI of $2,000, they would have $616.00 more in disposable income.

As mentioned above, financial/retirement planning for Medicare Part B and Part D Premiums require that planning cycles must be at least two years and preferably longer based on the current system. This is due to the requirement that the MAGI and income tax filing status of two years ago determines the Medicare Part B and Part D Premiums of a current year. The system of the invention can determine and assist in timing the receipt of MAGI to lower Medicare Part B and Part D IRMAA surcharges for a given year based on the MAGI and income tax filing status of two years ago. Based on the invention, even missed opportunities to save based on the determinations from the system may be realized by filing an amended tax return or by having a Life-Changing Event and filing Form SSA-44. Financial planning to minimize the Medicare Part B and Part D Premiums can thus take into account the ability to “time” MAGI for a given year to lower Medicare Premiums in the future, as well as determining what filing status to use to reduce the Part B and Part D Medicare premiums and possible IRMAA surcharges. The potential IRMAA surcharges can be lowered by “timing” MAGI between tax years and the choice of income tax filing status.

The Patient Protection and Affordable Care Act (PL111-148) and the Health Care and Education Reconciliation Act of 2010 (PL111-152) often referred to as The Affordable Care Act or sometimes referred to as “Obama Care” also has IRMAA surcharges for Medicare Part D for upper income individuals effective for 2011. Prior to 2011, there were no IRMAA surcharges for Part D. The MAGI ranges used to determine the IRMAA surcharges for Part D are the same as those used to determine the IRMAA surcharges for Part B. For 2014 the IRMAA surcharges for Medicare Part D have a range of $12.10 to $69.30, per beneficiary per month based on MAGI and income tax filing status used on the 2012 federal income tax return. The Affordable Care Act also freezes the income-related Part B and Part D premiums MAGI ranges at the 2010 levels through 2019. The maximum Medicare Part B IRMAA surcharge is $230.80, per beneficiary per month for 2014. The maximum Medicare Part D IRMAA surcharge is $69.30, per beneficiary per month for 2014. A married couple both on Medicare Part B and Part D and paying the maximum surcharge would have a standard Part B Premium of $104.90, plus a Part B surcharge of $230.80, plus a Part D surcharge of $69.30, plus a standard Part D premium which varies by the Part D plan chosen. The Medicare Part B surcharges for 2014 are the same as for 2013. In addition there would be a standard Medicare Part D Premium based on the subscription drug plan chosen. In addition there could be a Medigap policy to help pay deductibles and co-payments of Medicare Part A and Part B. Total health care costs for a high income couple paying the maximum IRMAA surcharge, Part D premium and a Medigap policy could be over $10,000 per year. For an unmarried individual, the total costs may be over $5,000 per year. Based on the invention, the costs associated with such premiums and potential surcharges can be minimized to save individuals significant out of pocket costs.

Based upon the foregoing disclosure, the system and methods as described herein will allow determination of minimum expenditures for individuals that may be subject to Medicare premium surcharges. It is, therefore, to be understood that any variations evident fall within the scope of the claimed invention can be determined without departing from the spirit of the invention herein disclosed and described.

What is claimed is:

1. A system for determining minimum expenditures relating to Medicare premium surcharges comprising:
the system accepting input of the age of spouses and determining if each of the spouses qualifies for Medicare Part B benefits in a current year (T1), a next year from the current year (T2) or the second year from the current year (T3), and if so, for accepting input of the Modified Adjusted Gross Income (MAGI) for each spouse for the current year (T1) and determining if the MAGI of one or both of the spouses is above a predetermined amount, and if so, accepting input of the plural estimates of the MAGI for each spouse for the current year (T1) along with the months each spouse is qualified for Medicare Part B and Part D benefits for the second year from the current year (T3), and determining Medicare premiums and any associated surcharges for each spouse based on the values of different estimated MAGI for each spouse to determine any penalty or savings in terms of Medicare premiums and any associated surcharges based on the estimated MAGI values for each spouse in year T1, wherein the individual uses the determination to minimize Medicare premiums and surcharges for year T3.

2. The system of claim 1, further comprising:
the system accepting input of the occurrence of a Life-Changing Event (LCE) under Medicare for a married individual and if so, inputting (a) MAGI for the current year (T1) and determining if the MAGI is above a predetermined amount, and if so, accepting inputs of (a) MAGI for the previous year (T−1), (b) MAGI for the current year (T1), (c) MAGI estimated for the next year from the current year (T2), (d) MAGI estimated for the second year from the current year (T3), (e) months on Part B for the next year from the current year (T2), (f) months on Part D for the next year from the current year (T2), (g) months on Part B for the second year from the current year (T3), (h) months on Part D for the second year from the current year (T3), months on Part B for the third year from the current year (T4) and months on Part D for the third year from the current year (T4), and determining the Medicare Part B and Part D premiums for the next year from the current year (T2), the second year from the current year (T3) and the third year from the current year (T4) wherein the system provides an indication of the years MAGI that results in the lowest total of Medicare Part B and Part D premiums for the years T2, T3 and T4 based on the occurrence of LCE, or if the MAGI for the current year (T1) is not above a predetermined amount, inputting (a) MAGI for the previous year (T−1) and determining if the MAGI is above a predetermined amount, and if so, accepting inputs of (a) MAGI for the previous year (T−1), (b) MAGI for the current year (T1), (c) MAGI estimated for the next year from the current year (T2), (d) MAGI estimated for the second year from the current year (T3), (e) months on Part B for the next year from the current year (T2), (f) months on Part D for the next year from the current year (T2), (g) months on Part B for the second year from the current year (T3), (h) months on Part D for the second year from the current year (T3), months on Part B for the third year from the current year (T4) and months on Part D for the third year from the current year (T4), and determining the Medicare Part B and Part D premiums for the next year from the current year (T2), the second year from the current year (T3) and the third year from the current year (T4) wherein the system provides an indication of the years MAGI that results in the lowest total of Medicare Part B and Part D premiums for the years T2, T3 and/or T4 based on the occurrence of LCE.

3. The system of claim 1, further comprising:
the system accepting input of the tax liability for each spouse using married filing jointly (MFJ) and married filing separately (MFS) status for T1 using the MAGI or estimated MAGI of the prior year (T−1), current year (T1) and next year from the current year (T2), and the system determining the minimum Medicare premiums and surcharges and tax liability based on filing status for year T3.

4. A system for planning for minimum expenditures relating to Medicare premium surcharges comprising:
a system for accepting input of information and determining if the individual qualifies for Medicare Part B benefits in a current year (T1), a next year from the current year (T2) or the second year from the current year (T3), and if so, for accepting input of plural estimated Modified Adjusted Gross Income (MAGI) for the individual for the current year T1, plural estimated MAGI for the next year from the current year (T2) and plural estimated MAGI for the second year from the current year (T3) and the months on Medicare Part B and Part D for the second year from the current year (T3), the third year from the current year (T4), and the fourth year from the current year (T5) and determining from the plural estimates of the individual's MAGI for the current year (T1), for the next year from the current year (T2) and second year from the current year (T3) the Medicare premiums and any associated surcharges based on the values of different estimated MAGI to determine any penalty or savings in terms of Medicare premiums and any associated surcharges based on the estimated MAGI values for years T1, T2 and T3, wherein the individual uses the determination to minimize Medicare Part B and Part D premiums for the second year from the current year (T3), the third year from the current year (T4) and the fourth year from the current year (T5).

5. The system of claim 4, further comprising:
the system accepting input of information of spouses and determining if each of the spouses qualifies for Medicare Part B benefits in a current year (T1), a next year from the current year (T2) or the second year from the current year (T3), and if so, for accepting input of the Modified Adjusted Gross Income (MAGI) for the current year (T1), the estimated MAGI for the next year from the current year (T2) or the second year from the current year (T3) and determining if the MAGI of one or both of the spouses is above a predetermined amount, and if so, accepting input of the plural estimates of the MAGI for each spouse for the current year (T1), for the next year from the current year (T2) and second year from the current year (T3) along with the months each spouse is qualified for Medicare Part B and Part D benefits for the second year from the current year (T3), the third year from the current year (T4) and the fourth year from the current year (T5) and determining Medicare premiums and any associated surcharges for each spouse based on the values of different estimated MAGI for each spouse for filing Married Filing Jointly (MFJ) and Married Filing Separately (MFS) status for T3, T4 and T5 to minimize Medicare Part B and Part D premiums for each spouse in the second year from the current year (T3), the third year from the current year (T4) and the fourth year from the current year (T5).

6. The system of claim 4, further comprising:
the system accepting input of the occurrence of a Life-Changing Event (LCE) under Medicare, and information of spouses and determining if each of the spouses qualifies for Medicare Part B benefits in a current year (T1), a next year from the current year (T2) or the second year from the current year (T3), and if so, for accepting input of the Modified Adjusted Gross Income (MAGI) for the current year (T1), the estimated MAGI for the next year from the current year (T2) or the second year from the current year (T3) and determining if the MAGI of one or both of the spouses is above a predetermined amount, and if so, accepting input of the plural estimates of the MAGI for each spouse for the current year (T1), for the next year from the current year (T2) and second year from the current year (T3) along with the months each spouse is qualified for Medicare Part B and Part D benefits for the second year from the current year (T3), the third year from the current year (T4) and the fourth year from the current year (T5) and determining Medicare premiums and any associated surcharges for each spouse based on the values of different estimated MAGI for each spouse for filing Married Filing Jointly (MFJ) and Married Filing Separately (MFS) status for T3, T4 and T5 to minimize Medicare Part B and Part D premiums for each spouse in the second year from the current year (T3), the third year from the current year (T4) and the fourth year from the current year (T5), wherein the system provides an indication of the years MAGI that results in the lowest total of Medicare Part B and Part D premiums for the years T3, T4 and/or T5 based on the occurrence of a LCE.

7. The system of claim 4, further comprising:
the system accepting input of the occurrence of a Life-Changing Event (LCE) under Medicare and if so, inputting (a) MAGI for the previous year (T−1), (b) MAGI for the current year (T1), (c) MAGI estimated for the next year from the current year (T2), (d) MAGI estimated for the second year from the current year (T3), (e) months on Part B for the next year from the current year (T2), (f) months on Part D for the next year from the current year (T2), (g) months on Part B for the second year from the current year (T3), (h) months on Part D for the second year from the current year (T3), (i) months on Part B for the third year from the current year (T4) and (j) months on Part D for the third year from the current year (T4), and determining the Medicare Part B and Part D premiums for the next year from the current year (T2) using the (a) MAGI for the previous year (T−1), (b) MAGI for the current year (T1), (c) MAGI estimated for the next year from the current year (T2), and (d) MAGI estimated for the second year from the current year (T3), wherein the system provides an indication of the years MAGI that results in the lowest total of Medicare Part B and Part D premiums for the years T2, T3 and/or T4 based on the occurrence of LCE.

8. The system of claim 4, further comprising:
the system accepting input of the occurrence of a Life-Changing Event (LCE) under Medicare and if so, accepting input of information and determining if the individual qualifies for Medicare Part B benefits in a current year (T1), a next year from the current year (T2) or the second year from the current year (T3), and if so, for accepting input of plural estimated Modified Adjusted Gross Income (MAGI) for the individual for the current year T1, plural estimated MAGI for the next year from the current year (T2) and plural estimated MAGI for the second year from the current year (T3) and the months on Medicare Part B and Part D for the second year from the current year (T3), the third year from the current year (T4), and the fourth year from the current year (T5) and determining from the plural estimates of the individual's MAGI for the current year (T1), for the next year from the current year (T2) and second year from the current year (T3) the Medicare premiums and any associated surcharges based on the values of different estimated MAGI to determine any penalty or savings in terms of Medicare premiums and any associated surcharges based on the estimated MAGI values for years T1, T2 and T3, wherein the individual uses the determination to minimize Medicare Part B and Part D premiums for the second year from the current year (T3), the third year from the current year (T 4) and the fourth year from the current year (T5) based on the occurrence of a LCE.

9. The system of claim 4, further comprising:
the system accepting input of the occurrence of a Life-Changing Event (LCE) under Medicare for a married individual and if so, inputting for each spouse the (a) MAGI for the previous year (T−1), (b) MAGI for the current year (T1), (c) MAGI estimated for the next year from the current year (T2), (d) MAGI estimated for the second year from the current year (T3), (e) months on Part B for the next year from the current year (T2), (f) months on Part D for the next year from the current year (T2), (g) months on Part B for the second year from the current year (T3), (h) months on Part D for the second year from the current year (T3), months on Part B for the third year from the current year (T4) and months on Part D for the third year from the current year (T4), and determining the Medicare Part B and Part D premiums for the next year from the current year (T2) using the (a) MAGI for the previous year (T−1), (b) MAGI for the current year (T1), (c) MAGI estimated for the next year from the current year (T2), and (d) MAGI estimated for the second year from the current year (T3) to calculate the lowest Medicare Part B and Part D premiums for T2, T3 and/or T4 based on the occurrence of LCE.

10. A system for planning for minimum expenditures relating to Medicare premium surcharges comprising:
a system for accepting input of information and determining if the individual qualifies for Medicare Part B benefits in a first year (T1), a next year from the first year (T2) or the second year from the first year (T3), and if so, for accepting input of estimated Modified Adjusted Gross Income (MAGI) for the individual related to a first year T1 and determining if it is above a predetermined amount, and if so, for accepting inputs of plural estimated MAGI for year T1, and months on Medicare Part B and D in the second year T3 from year T1, and determining from the plural estimates of the individual's MAGI for the year T1 the Medicare premiums and any associated surcharges based on the values of different estimated MAGI to determine any penalty or savings in terms of Medicare premiums and any associated surcharges based on the estimated MAGI values for year T1, wherein the individual uses the determination to minimize Medicare Part B and Part D premiums for the second year T3 from year T1.

11. The system of claim 10, further comprising:
the system accepting input of information of spouses and determining if each of the spouses qualifies for Medicare Part B benefits in a first year (T1), a next year from the first year (T2) or the second year from the first year (T3), and if so, for accepting input of estimated Modified Adjusted Gross Income (MAGI) for each of the spouses related to year T1 and determining if the MAGI in year T1 are above a predetermined amount, and if so, for accepting input of plural Modified Adjusted Gross Income (MAGI) for the year T1 for each spouse, along with the months each spouse is qualified for Medicare Part B and Part D benefits for the year T3, and determining Medicare premiums and any associated surcharges for each spouse based on the values of different estimated MAGI for each spouse in year T1 for filing Married Filing Jointly (MFJ) and Married Filing Separately (MFS) status to minimize Medicare Part B and Part D premiums for each spouse in year T3.
